(19) United States
(12) Patent Application Publication
(10) Pub. No.: US 2026/0330158 A1
(43) Pub. Date: Oct. 22, 2026

(54) SYSTEM

(71) Applicant: SoftBank Group Corp., Tokyo (JP)

(72) Inventor: Kensuke FUKUSHIMA, Tokyo (JP)

(73) Assignee: SoftBank Group Corp., Tokyo (JP)

(21) Appl. No.: 19/649,142

(22) Filed: Apr. 16, 2026

(30) Foreign Application Priority Data
Apr. 22, 2025 (JP) 2025-070934

(51) Int. Cl. G06F 40/58; G06F 40/284; G06F 40/51; G06T 19/00; G10L 15/26; H04L 65/1069

(52) U.S. Cl. CPC G06F 40/58; G06F 40/284; G06F 40/51; G06T 19/00; G10L 15/26; H04L 65/1069; G06T 2219/024

(57) ABSTRACT

The present invention relates to a virtual office system for realizing global collaboration by a multinational team, wherein a virtual space generation unit generates a metaverse space connecting multiple bases based on attribute information such as languages and cultural backgrounds of users, a communication support unit performs real-time translation, cultural adaptation, and emotion recognition using generative AI, and a project progress management unit analyzes activity histories and past data to autonomously propose progress optimization and cultural friction mitigation measures, thereby providing an efficient and smooth global collaboration environment beyond physical, language, and cultural barriers.

### CROSS-REFERENCE TO RELATED APPLICATION

The present application claims priority to and incorporates by reference the entire contents of Japanese Patent Application No. 2025-070934 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a complex problem faced by companies expanding their business globally, multinational teams, corporations and sole proprietors promoting remote work, international freelance communities, and the like, such as communication obstacles between international teams, that is, friction due to language barriers and cultural differences, furthermore, inefficiency of collaboration due to time differences and geographical restrictions, high costs for acquiring global human resources (relocation costs, visa procedures, etc.), and lack of speed and flexibility when executing international projects, and in that communication tools currently used as alternative means have insufficient real-time translation functions and cultural adaptation functions, and thus cannot sufficiently eliminate language and cultural barriers, hindering the utilization of global human resources and efficient project promotion by multinational teams. Furthermore, in conventional remote work environments, physical movement and geographical restrictions cannot be completely overcome, and there is a limit to promoting international human resource mobility and new business development. Therefore, a technical problem to be solved by the present invention is to comprehensively and fundamentally solve these problems and provide a new virtual office environment in which a multinational team can smoothly and efficiently collaborate beyond physical restrictions and language and cultural barriers.

### SUMMARY OF THE INVENTION

Means for solving the above problems is to provide a system for realizing global collaboration by a multinational team, and the system is configured to include a virtual space generation unit, a communication support unit, and a project progress management unit. The virtual space generation unit receives access from a plurality of physically separated bases and user terminals, registers language information and cultural background information as attribute information of each user, and generates a virtual office space in which the multinational team can simultaneously participate based on the information. The communication support unit translates text or voice messages between users in real time using generative AI, further performs a cultural adaptation process of automatically adjusting expressions and nuances according to the cultural background of each user, additionally applies an emotion recognition algorithm by the generative AI to analyze an emotional state of the exchanged messages, and visualizes quality and atmosphere of communication. The project progress management unit retains activity histories of the users in the virtual space and past project data as long-term memory, grasps a progress status, extracts issues, optimizes task sharing, detects signs of cultural friction, and proposes mitigation measures thereof through highly accurate data analysis by the generative AI, and further integrally and autonomously executes all of these processes by the generative AI, thereby providing a new virtual office environment in which the multinational team can smoothly and efficiently collaborate beyond physical restrictions and language and cultural barriers.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

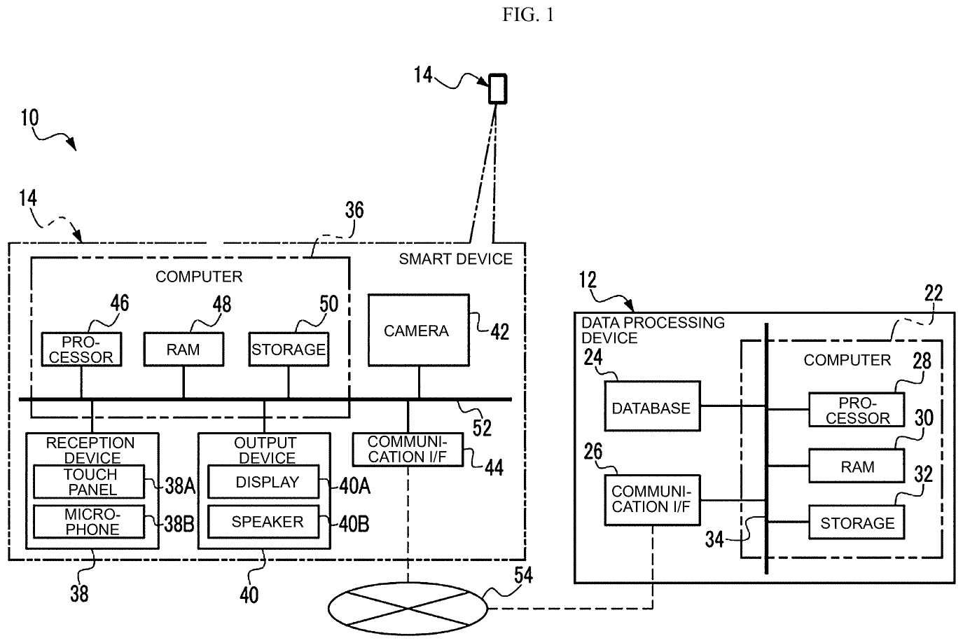

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

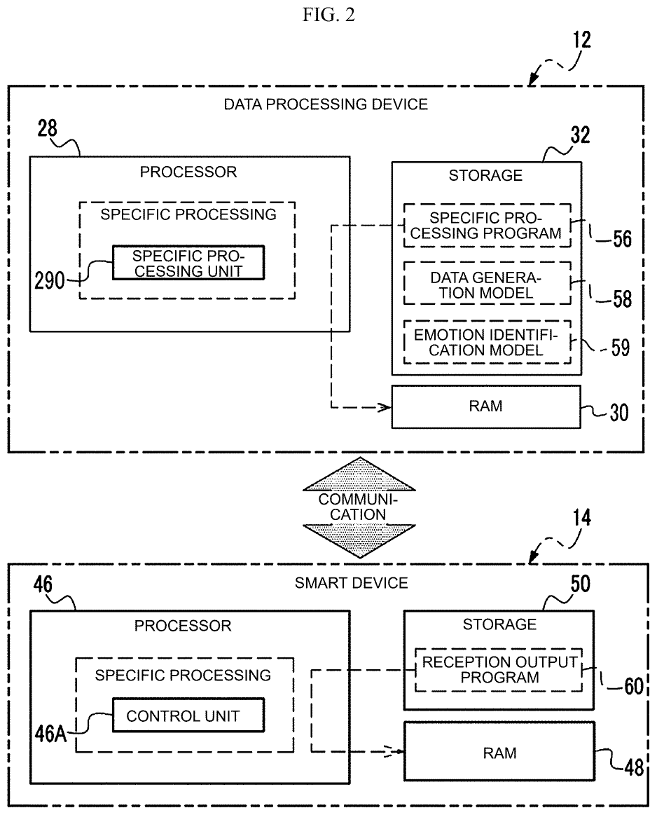

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment of the present invention, a system for realizing a virtual office environment in which a global multinational team can collaborate beyond physical restrictions and linguistic and cultural barriers is constructed by cooperative operation of a server and terminals. Hereinafter, each component, a method of utilizing generative AI, role sharing between the server and the terminals, and further specific usage examples and scenarios will be comprehensively and in detail described. Specifically, the present system adopts a distributed computing architecture. The present system utilizes a parallel computing cluster composed of a plurality of computing nodes. The present system includes an inference server hosting a large language model. The present inference server executes a transformer architecture equipped with a self-attention mechanism. The present system receives a multidimensional feature vector transmitted from a terminal. The present system converts the feature vector into a tensor format. The present system inputs the tensor data to the large language model. The present system uses, for example, a 512-dimensional word embedding vector as input data. The present system uses, for example, a 1024-dimensional voice feature vector as input data. The present system uses, for example, a 256-dimensional user profile vector as input data. The present system combines these input vectors to generate an integrated tensor. The present system supplies the integrated tensor to an input layer of the large language model. The present system executes a non-linear transformation in a hidden layer of the large language model. The present system outputs a probability distribution vector from an output layer. The present system outputs, for example, a probability score of a next appearing word as output data. The present system outputs, for example, a classification label of an emotional state as output data. The present system outputs, for example, a coordinate matrix of a spatial layout as output data. The present system decodes a token sequence with the highest probability from the probability distribution vector. The present system converts the decoded token sequence into a control command. The present system transmits the control command to each terminal. The present system thereby drives a drawing engine on the terminal side. The present system renders polygon data of a virtual space by the drawing engine. The present system outputs the rendered image data to a display. The present system reduces processing delay by such cooperative operation of hardware and software. The present system minimizes consumption of network bandwidth. The present system thereby realizes real-time synchronization of the virtual space. The present system analyzes a complex cultural context by vector operation in a high-dimensional space, unlike conventional rule-based processing. The present system optimizes weight parameters of the large language model in advance using a cross-entropy error function. The present system updates the weights by a gradient descent method. The present system thereby dramatically improves translation accuracy. The present system is applied to an online meeting system of a multinational company. The present system is applied to a virtual laboratory of an international joint research project. The present system is applied to a virtual reception desk of a global customer support center.

First, the virtual space generation unit is realized on the server side. The server receives user information (name, affiliation, language used, cultural background, time zone, job title, field of expertise, past project participation history, desired work style, avatar settings, preferred interface design, etc.) transmitted from user terminals, and generates a virtual office space optimized for each user based on the information. For example, in the case of a company having bases in a plurality of regions such as Asia, Europe, North America, South America, Africa, and Oceania, the server integrates physical location information and network information of each base, and constructs a metaverse space virtually connecting the bases. Various areas such as a conference room, an individual booth, a lounge, a project room, a cafeteria, an event hall, a library, a rest space, a reception area, a whiteboard area, and a presentation room are provided in the virtual space, and the user can freely move to these areas from the terminal. For example, it is also possible to automatically generate a dedicated virtual conference room or breakout room for each project, and dynamically optimize a layout and an interface according to attributes of participants. Furthermore, lighting and background sounds in the virtual space, and clothes and display languages of avatars can be automatically switched according to the time zone and working hours of the user. Specifically, the present virtual space generation unit is executed on a server equipped with a dedicated graphics processing unit. The present virtual space generation unit inputs text data received from the user terminal to a natural language processing model. The present natural language processing model converts a word into a 768-dimensional dense vector. The present virtual space generation unit converts a categorical variable into a one-hot vector. The present virtual space generation unit combines these vectors to generate a 2048-dimensional user feature tensor. The present virtual space generation unit inputs this tensor to a generator of a generative adversarial network. The present generator includes a plurality of transposed convolution layers. The present generator generates voxel data of a three-dimensional space from the input tensor. The present voxel data has a resolution of, for example, 256 by 256 by 256. The present virtual space generation unit converts this voxel data into a polygon mesh. The present virtual space generation unit outputs a vertex coordinate matrix of the polygon mesh. The present virtual space generation unit outputs, for example, texture mapping coordinates of a wall or a floor as output data. The present virtual space generation unit outputs, for example, an environmental parameter vector of a light source as output data. The present virtual space generation unit outputs, for example, initial arrangement coordinates of an avatar as output data. The present virtual space generation unit transmits this vertex coordinate matrix to a rendering engine. The present rendering engine calculates a depth map of the virtual space based on the vertex coordinate matrix. The present rendering engine executes occlusion culling using the depth map. The present virtual space generation unit significantly reduces the amount of calculation required for drawing by this process. The present virtual space generation unit reduces memory consumption of the server. The present virtual space generation unit compresses the amount of data transmitted via a network. The present virtual space generation unit thereby minimizes drawing delay on the terminal side. The present virtual space generation unit is applied to construction of a virtual head office of a multinational company. The present virtual space generation unit is applied to venue generation of an international online exhibition. The present virtual space generation unit is applied to virtual campus construction of a global educational institution.

The communication support unit is mainly realized on the server side, but some user interfaces and real-time display processing are also executed on the terminal side. The communication support unit translates messages such as text chats, voice calls, video conferences, whiteboard sharing, file sharing, and emotional expressions using stamps and emojis between users in real time using generative AI. For example, content spoken in Japanese is simultaneously translated into multiple languages such as English, Chinese, Spanish, French, German, Arabic, and Hindi, and distributed to each user terminal. A large language model of the generative AI is used for the translation process, and technical terms, industry-specific expressions, abbreviations, slang, dialects, business terms, internal terms, and project-specific abbreviations are also supported. For example, when terms such as “API”, “deploy”, and “agile” appear in an IT project, they are converted into appropriate technical terms in each language. Furthermore, the generative AI refers to the cultural background and past communication history of each user, business manners by country, religious considerations, gender expressions, switching between honorific and casual expressions, interpretation of humor and irony, meanings of non-verbal expressions (gestures and facial expressions), and the like, and automatically performs a cultural adaptation process, such as converting an honorific expression of Japanese culture into a casual expression of American culture, adjusting a euphemistic expression of European culture into a direct expression of Asian culture, or converting into an expression reflecting religious considerations of the Islamic cultural sphere. For example, when a member in India says “I will consider it”, the intention can be clarified and conveyed to a member in the United States as “I'll get back to you soon.” In addition, an emotion recognition algorithm by the generative AI is used to analyze an emotional state such as positive, negative, stress, tension, relief, anger, confusion, expectation, joy, disappointment, and fatigue from the tone of messages and utterances, facial expressions, gestures, voice intonation, speech speed, chat input speed, frequency of use of emojis and stamps, and the like, and visualize it on the screen of the terminal with icons, color coding, graphs, heat maps, changes in facial expressions of avatars, and the like. For example, when the stress of some members increases during a meeting, the AI can automatically insert a facilitation message and make a proposal for mitigating the discussion or taking a break, such as “The discussion seems to be heating up. I propose a 5-minute break.” or “Opinions seem to be divided. Let's organize each person's position.” Furthermore, the AI can analyze the number of utterances, utterance time, diversity of utterance content, number of reactions to others, and the like of the user, and automatically generate an utterance promotion message such as “I would also like to hear Mr./Ms. XX's opinion” for a member who speaks infrequently. Specifically, the present communication support unit executes a pipeline integrating a voice recognition model, a large language model, and a convolutional neural network for emotion recognition. The present communication support unit uses, for example, voice waveform data with a sampling rate of 16,000 hertz as input data. The present communication support unit uses, for example, a two-dimensional tensor of Mel-frequency cepstral coefficients extracted from the voice waveform as input data. The present communication support unit uses, for example, a facial landmark coordinate vector extracted from a camera image as input data. The present communication support unit inputs the voice waveform data to the voice recognition model to generate a text token sequence. The present communication support unit combines this text token sequence and a cultural attribute vector of the user. The present communication support unit inputs the combined tensor to the large language model. The present large language model has an encoder and decoder structure. The present large language model calculates context dependencies by a self-attention mechanism. The present communication support unit outputs, for example, a text token sequence of a translation target language as output data. The present communication support unit outputs, for example, a candidate list of culturally adapted alternative expressions as output data. The present communication support unit outputs, for example, a probability distribution vector indicating an emotional state such as positive or negative as output data. The present communication support unit inputs this probability distribution vector to a threshold determination module. The present threshold determination module generates an alert signal when a specific emotion score exceeds a specified value. The present communication support unit automatically generates a facilitation message based on this alert signal. The present communication support unit multicasts the generated text and emotion data to each terminal. The present communication support unit realizes real-time cross-cultural communication without human interpreters by this process. The present communication support unit reduces the calculation load on the terminal side by batch processing on the server side. The present communication support unit is applied to a multilingual international conference system. The present communication support unit is applied to a daily scrum meeting of a multinational development team. The present communication support unit is applied to a global online business negotiation platform.

The project progress management unit is mainly realized on the server side. The server accumulates activity histories of users in the virtual space (conference participation history, utterance content, task completion status, file sharing history, minutes, chat logs, whiteboard writing content, project milestone achievement status, contribution degree of each user, feedback history, questionnaire results, evaluation scores, etc.) and past project data as long-term memory. The generative AI analyzes these large amounts of data, and when detecting a sign of progress delay, for example, performs review of task sharing, proposal of additional resources, proposal of increasing communication frequency, automatic reminder of progress reports, automatic extraction of delay factors, prediction of risk factors, automatic generation of progress graphs and Gantt charts, and the like. In addition, when detecting signs of cultural friction (such as when negative emotions frequently occur in interactions between specific members, when an atmosphere in which members of a specific country or cultural sphere find it difficult to speak continues, or when consensus building in a meeting does not progress), the AI presents arbitration proposals and facilitation proposals, and makes proposals such as “Differences in cultural backgrounds may be affecting the discussion. Let's organize the opinions of each country in order.” or “In past similar projects, a consensus building process like XX was effective.”, thereby supporting smooth operation of the team. In the initial stage of a project, the AI can also extract success patterns and failure cases of past similar projects, and propose an optimal progress schedule, risk management measures, a task breakdown plan, a role sharing plan, a communication rule plan, a meeting structure plan, a progress report format plan, and the like. Furthermore, the AI analyzes the skills, past contribution degree, field of expertise, strong field, past evaluation scores, recommendation history from other members, and the like of each user, and automatically proposes optimal task assignment, personnel placement, mentor-mentee combinations, recommendation of leader candidates, and an optimal team formation plan for each project. Specifically, the present project progress management unit executes a long short-term memory network or a time-series transformer specialized for time-series data analysis. The present project progress management unit periodically extracts activity log data from a database. The present project progress management unit uses, for example, a time-series array of task completion flags for the past 30 days as input data. The present project progress management unit uses, for example, a normalized numerical vector indicating the utterance frequency of each member as input data. The present project progress management unit uses, for example, a moving average tensor of emotion scores extracted from chat logs as input data. The present project progress management unit combines these input data along a time axis to generate a multidimensional time-series tensor. The present project progress management unit inputs this multidimensional time-series tensor to the time-series transformer. The present time-series transformer calculates attention weights between past patterns and current states. The present project progress management unit outputs, for example, a project delay probability score within the next week as output data. The present project progress management unit outputs, for example, an importance vector of a specific communication pattern causing cultural friction as output data. The present project progress management unit outputs, for example, a ranking matrix indicating task suitability of each member as output data. The present project progress management unit passes this output result to a rule-based inference engine. The present inference engine triggers a resource reallocation algorithm when the delay probability score exceeds a threshold. The present project progress management unit generates an optimal task assignment change plan by this algorithm. The present project progress management unit detects minute progress delays and discord within the team, which are difficult for human managers to notice, at an early stage by this process. The present project progress management unit quantitatively improves the success probability of a project by a data-driven approach. The present project progress management unit is applied to a management tool for a large-scale software development project. The present project progress management unit is applied to progress management of a multinational marketing campaign. The present project progress management unit is applied to an international supply chain construction project.

On the terminal side, it is responsible for displaying a user interface, receiving input from a user, displaying translation results and emotion analysis results in real time, operating an avatar in the virtual space, uploading/downloading files, receiving notifications, operating a whiteboard and chat, participating in/leaving a meeting, answering questionnaires, inputting feedback, approving/rejecting AI proposals, and the like. For example, when a user enters a virtual conference room from a terminal, layout information of the conference room, a participant list, translated and culturally adapted message history, visualization information of emotional states, progress graphs, a task list, a meeting agenda, file sharing links, whiteboard contents, and the like are transmitted from the server to the terminal, and the terminal displays them in real time. When the user speaks by voice, the terminal transmits voice data to the server, and after the generative AI on the server side performs translation, cultural adaptation, and emotion recognition processing, messages and voice data optimized for each recipient terminal are distributed. For example, content spoken in Chinese during a meeting is simultaneously displayed on each user terminal in English, Japanese, and Spanish, and is conveyed in expressions tailored to each culture. When a user writes a figure or a memo on the whiteboard, the content is also automatically translated into multiple languages, enabling members of each country to understand it in their own language. Specifically, the present terminal functions as an edge computing device. The present terminal executes drawing processing using a built-in graphics processing unit. The present terminal uses, for example, a two-dimensional coordinate vector from a touch panel as input data. The present terminal uses, for example, an RGB image tensor of 30 frames per second acquired from a built-in camera as input data. The present terminal uses, for example, multi-channel voice waveform data acquired from a microphone array as input data. The present terminal applies a lightweight neural network on the edge device to these input data. The present lightweight neural network adopts, for example, a MobileNet architecture. The present terminal outputs, for example, a three-dimensional vector indicating a gaze direction of the user as output data. The present terminal outputs, for example, a joint coordinate matrix indicating a skeletal posture of the user as output data. The present terminal outputs, for example, a clean voice feature vector from which background noise has been removed as output data. The present terminal transmits these output data to the server as difference data. The present terminal expands polygon data and texture data received from the server into a local memory. The present terminal executes a shader program to render the virtual space on a display. The present terminal overlays and displays the translated text data at specified coordinates on the screen. The present terminal distributes the calculation load of the server by this preprocessing and drawing processing on the edge side. The present terminal reduces the amount of communication data with the server and saves network bandwidth. The present terminal thereby suppresses response delay to user operations to the order of milliseconds. The present terminal is applied to a mobile device such as a smartphone or a tablet. The present terminal is applied to a virtual reality headset or augmented reality glasses. The present terminal is applied to a desktop personal computer or a dedicated video conference terminal.

In addition, the generative AI also learns user behavior patterns, project progress statuses, team dynamics, past success/failure cases, feedback and evaluations from users, external business news and industry trends, national holidays and event information of each country, current affairs, laws and regulations, exchange rates and logistics statuses, and the like, and contributes to optimization of the entire system. For example, it is also possible for the AI to learn a tendency for communication to become active in a specific time zone and automatically propose scheduling of important meetings and tasks, automatically adjust project milestones in consideration of national holidays and large-scale events of each country, or predict risks of exchange rate fluctuations and logistics delays and present supply chain adjustment plans. Furthermore, the AI collects user feedback and evaluations, and continuously improves algorithms for translation accuracy and the cultural adaptation process. For example, when a user inputs feedback such as “This translation was unnatural”, “This expression is considered rude in my culture”, or “This AI proposal does not match the actual situation on site”, the AI learns the content and reflects it in subsequent translations and proposals. Specifically, the present system includes a reinforcement learning agent and a fine-tuning module. The present system executes a continuous learning pipeline in the background. The present system uses, for example, pair data of translated texts corrected by the user as input data. The present system uses, for example, a five-level evaluation score vector for AI proposals as input data. The present system uses, for example, an embedding tensor of text data scraped from external news sites as input data. The present system converts these input data into a learning dataset by batch processing. The present system fine-tunes weight parameters of the large language model using the learning dataset. The present system efficiently updates only some parameters of the model using a low-rank adaptation method. The present system outputs, for example, a difference matrix of the updated weight parameters as output data. The present system outputs, for example, an optimization parameter of a reward function of a scheduling algorithm as output data. The present system outputs, for example, a coefficient vector of a new risk prediction model reflecting changes in the external environment as output data. The present system dynamically loads this difference matrix into an inference server in a production environment. The present system improves the performance of the AI model without system downtime by this process. The present system increases the accuracy of personalization by converting implicit feedback from users into explicit learning signals. The present system realizes the adaptability of the system to fluctuations in the external environment as computer technology. The present system is applied to a market prediction and team collaboration system of a global financial institution. The present system is applied to a supply chain optimization platform of a multinational manufacturing industry. The present system is applied to a knowledge management system of an international consulting firm.

As described above, in the embodiment of the present invention, the functions of the virtual space generation unit, the communication support unit, and the project progress management unit are mainly realized on the server side, and the terminal side is responsible for the user interface, real-time display processing, and user input reception, thereby providing an advanced multinational team collaboration environment with the generative AI at its core. For example, in any multinational and multicultural team, such as a global new business development project, an international research and development team, a remote work-based startup, a large corporation with bases in multiple countries, an international freelance group, an international conference or academic society, a global educational program, an international volunteer activity, cross-border supply chain management, an international marketing campaign, an overseas base launch project, an international legal and intellectual property team, and a global customer support center, efficient and smooth collaboration beyond physical, linguistic, and cultural barriers can be realized. Furthermore, through automatic learning and optimization by the AI, the system continuously evolves, making it possible to continue flexibly responding to diverse needs of users and changes in the global environment. Specifically, the present system adopts a cloud-native microservices architecture. The present system deploys each functional module as an independent container. The present system uses, for example, time-series metrics of CPU usage and memory consumption of the entire system as input data. The present system uses, for example, a network traffic matrix indicating communication delay between microservices as input data. The present system uses, for example, a prediction vector of the number of simultaneously connected users as input data. The present system inputs these input data to a resource allocation optimization model. The present resource allocation optimization model executes a deep reinforcement learning algorithm. The present system outputs, for example, an allocation ratio of server resources to each container as output data. The present system outputs, for example, a control command instructing scale-out of the inference server as output data. The present system outputs, for example, a change parameter of a replication setting of a database as output data. The present system drives a container orchestration tool based on this output result. The present system maintains system stability even against a sudden increase in traffic by this process. The present system minimizes operation costs by releasing unnecessary server resources. The present system improves the availability of the entire computer system by dynamic and autonomous management of hardware resources. The present system is applied to a virtual platform for an international mega-event requiring simultaneous connections on the scale of tens of thousands of people. The present system is applied to a collaborative environment for an open source project in which thousands of developers distributed around the world participate. The present system is applied to a remote diagnosis and conference system by a multinational team of medical experts.

### System Configuration

The system according to the present embodiment includes a virtual space generation unit, a communication support unit, a project progress management unit, a user interface unit, a database management unit, a security management unit, and a generative AI cooperation unit. The virtual space generation unit receives various attribute information such as name, affiliation, language used, cultural background, time zone, job title, field of expertise, past project participation history, desired work style, avatar settings, and preferred interface design as user information transmitted from user terminals, and generates a virtual office space optimized for each user based on the information. For example, in the case of a company having bases in a plurality of regions such as Asia, Europe, North America, South America, Africa, and Oceania, physical location information and network information of each base are integrated, and a metaverse space virtually connecting the bases is constructed. Various areas such as a conference room, an individual booth, a lounge, a project room, a cafeteria, an event hall, a library, a rest space, a reception area, a whiteboard area, and a presentation room are provided in the virtual space, and the user can freely move to these areas from the terminal. For example, it is also possible to automatically generate a dedicated virtual conference room or breakout room for each project, and dynamically optimize a layout and an interface according to attributes of participants. Furthermore, lighting and background sounds in the virtual space, and clothes and display languages of avatars can be automatically switched according to the time zone and working hours of the user. Specifically, the present virtual space generation unit operates on a dedicated server instance equipped with a hardware accelerator. The present virtual space generation unit uses, for example, structured data in JSON format including user attribute information as input data. The present virtual space generation unit uses, for example, a geospatial coordinate vector including latitude and longitude information of each base as input data. The present virtual space generation unit uses, for example, a numerical array in milliseconds indicating network delay time as input data. The present virtual space generation unit inputs these input data to a multilayer perceptron to convert them into a latent space vector. The present virtual space generation unit inputs this latent space vector to a conditional generative model. The present conditional generative model adopts an architecture of a variational autoencoder. The present virtual space generation unit outputs, for example, an adjacency matrix indicating a topology of the virtual space as output data. The present virtual space generation unit outputs, for example, a coordinate tensor of a three-dimensional bounding box indicating dimensions of each room as output data. The present virtual space generation unit outputs, for example, a lighting parameter vector indicating color temperature and intensity of environmental light as output data. The present virtual space generation unit dynamically constructs a scene graph based on this output data. The present virtual space generation unit distributes this scene graph to each terminal to instruct local rendering. The present virtual space generation unit provides a personalized space while avoiding heavy graphics processing on the server side by this process. The present virtual space generation unit realizes a rich visual experience while suppressing consumption of network bandwidth. The present virtual space generation unit is applied to a joint production studio of a multinational creator team. The present virtual space generation unit is applied to a virtual property guidance system of a global real estate company. The present virtual space generation unit is applied to a virtual viewing arena of an international e-sports tournament.

The communication support unit has a function of translating messages such as text chats, voice calls, video conferences, whiteboard sharing, file sharing, and emotional expressions using stamps and emojis between users in real time. For example, content spoken in Japanese is simultaneously translated into multiple languages such as English, Chinese, Spanish, French, German, Arabic, and Hindi, and distributed to each user terminal. A large language model of the generative AI is used for the translation process, and technical terms, industry-specific expressions, abbreviations, slang, dialects, business terms, internal terms, and project-specific abbreviations are also supported. For example, when terms such as “API”, “deploy”, and “agile” appear in an IT project, they are converted into appropriate technical terms in each language. Furthermore, by referring to the cultural background and past communication history of each user, business manners by country, religious considerations, gender expressions, switching between honorific and casual expressions, interpretation of humor and irony, meanings of non-verbal expressions (gestures and facial expressions), and the like, a cultural adaptation process is automatically performed, such as converting an honorific expression of Japanese culture into a casual expression of American culture, adjusting a euphemistic expression of European culture into a direct expression of Asian culture, or converting into an expression reflecting religious considerations of the Islamic cultural sphere. For example, when a member in India says “I will consider it”, the intention can be clarified and conveyed to a member in the United States as “I'll get back to you soon.” In addition, an emotion recognition algorithm by the generative AI is used to analyze an emotional state such as positive, negative, stress, tension, relief, anger, confusion, expectation, joy, disappointment, and fatigue from the tone of messages and utterances, facial expressions, gestures, voice intonation, speech speed, chat input speed, frequency of use of emojis and stamps, and the like, and visualize it on the screen of the terminal with icons, color coding, graphs, heat maps, changes in facial expressions of avatars, and the like. For example, when the stress of some members increases during a meeting, the AI can automatically insert a facilitation message and make a proposal for mitigating the discussion or taking a break, such as “The discussion seems to be heating up. I propose a 5-minute break.” or “Opinions seem to be divided. Let's organize each person's position.” Furthermore, the AI can analyze the number of utterances, utterance time, diversity of utterance content, number of reactions to others, and the like of the user, and automatically generate an utterance promotion message such as “I would also like to hear Mr./Ms. XX's opinion” for a member who speaks infrequently. Specifically, the present communication support unit executes pipeline processing of data using a stream processing engine. The present communication support unit uses, for example, a spectrogram tensor of voice sampled in real time as input data. The present communication support unit uses, for example, a character code array of a text chat as input data. The present communication support unit uses, for example, a time-series vector in milliseconds indicating intervals of keystrokes as input data. The present communication support unit inputs these input data to a multimodal integration model. The present multimodal integration model maps voice, text, and behavior data to a common latent space. The present communication support unit outputs, for example, a Unicode character string of translated text as output data. The present communication support unit outputs, for example, an output vector of a softmax function indicating a probability of each emotion category as output data. The present communication support unit outputs, for example, a binary flag serving as a generation trigger for a facilitation message as output data. The present communication support unit distributes this output result to each terminal via a publish-subscribe messaging system. The present communication support unit minimizes translation delay for a large number of simultaneously connected users by this asynchronous processing architecture. The present communication support unit realizes cultural adaptation by mathematical operations in a high-dimensional vector space rather than imitating human cognitive processes. The present communication support unit is applied to a multilingual online customer support system. The present communication support unit is applied to an international remote medical consultation platform. The present communication support unit is applied to an online language learning system in which multinational students participate.

The project progress management unit accumulates activity histories of users in the virtual space (conference participation history, utterance content, task completion status, file sharing history, minutes, chat logs, whiteboard writing content, project milestone achievement status, contribution degree of each user, feedback history, questionnaire results, evaluation scores, etc.) and past project data as long-term memory, and analyzes these large amounts of data using generative AI. For example, when a sign of progress delay is detected, it performs a review of task sharing, a proposal of additional resources, a proposal to increase communication frequency, an automatic reminder of progress reports, automatic extraction of delay factors, prediction of risk factors, automatic generation of progress graphs and Gantt charts, and the like. In addition, when signs of cultural friction (such as a case where negative emotions frequently occur in interactions between specific members, a case where an atmosphere in which members of a specific country or cultural sphere find it difficult to speak continues, a case where consensus building in a meeting does not progress, etc.) are detected, the AI presents arbitration proposals and facilitation proposals, and makes proposals such as, for example, “Differences in cultural backgrounds may be affecting the discussion. Let's organize the opinions of each country in order.” and “In past similar projects, a consensus building process like XX was effective.”, thereby supporting smooth operation of the team. In an initial stage of a project, the AI can also extract success patterns and failure cases of past similar projects, and propose an optimal progress schedule, risk management measures, a task breakdown proposal, a role sharing proposal, a communication rule proposal, a meeting system proposal, a progress report format proposal, and the like. Furthermore, the AI analyzes the skills, past contribution degree, field of expertise, strong field, past evaluation score, recommendation history from other members, and the like of each user, and automatically proposes optimal task assignment, human resource allocation, mentor-mentee combinations, recommendation of leader candidates, and an optimal team formation proposal for each project. Specifically, the project progress management unit adopts a lambda architecture integrating batch processing and stream processing. The project progress management unit uses, as input data, directed acyclic graph data indicating task dependencies of past projects extracted from a database, for example. The project progress management unit uses, as input data, a multidimensional binary vector indicating a skill set of each member, for example. The project progress management unit uses, as input data, an array of floating-point numbers indicating a real-time task completion rate, for example. The project progress management unit inputs these input data into a graph convolutional network. The graph convolutional network learns relationships between nodes and extracts feature quantities. The project progress management unit outputs, as output data, a probability distribution tensor indicating a scheduled completion date of each task, for example. The project progress management unit outputs, as output data, a vector of network centrality scores indicating a communication bottleneck in the team, for example. The project progress management unit outputs, as output data, an assignment matrix indicating an optimal combination of members, for example. The project progress management unit passes this output result to a dashboard generation module to automatically generate a visual report. Through this process, the project progress management unit supports data-driven decision making that does not depend on the experience and intuition of a project manager. The project progress management unit identifies risk factors that are difficult for humans to discover through comprehensive analysis of large-scale data by a computer. The project progress management unit is applied to a process management system for a large-scale infrastructure construction project. The project progress management unit is applied to production management of a multinational film production team. The project progress management unit is applied to a progress tracking system of an international joint research consortium.

A user interface unit provides a multilingual and multicultural interface on a terminal so that a user can intuitively operate an avatar in the virtual space, move to a conference room, a lounge, a whiteboard area, or the like, and perform a chat, a voice call, a video conference, file sharing, stamp transmission, questionnaire answering, feedback input, approval/rejection of an AI proposal, and the like. For example, when a user enters a virtual conference room from a terminal, layout information of the conference room, a participant list, a translated and culturally adapted message history, visualization information of an emotional state, a progress graph, a task list, a meeting agenda, a file sharing link, contents of a whiteboard, and the like are transmitted from the server to the terminal, and the terminal displays these in real time. When a user speaks by voice, the terminal transmits voice data to the server, and after translation, cultural adaptation, and emotion recognition processing are performed by the generative AI on the server side, optimized messages and voice data are distributed to each recipient terminal. For example, content spoken in Chinese during a meeting is simultaneously displayed on each user terminal in English, Japanese, and Spanish, and is transmitted in expressions tailored to each culture. When a user writes a figure or a memo on the whiteboard, the content is also automatically translated into multiple languages, enabling members from each country to understand it in their own language. Specifically, the user interface unit is implemented as a dedicated client application operating on an operating system of the terminal. The user interface unit uses, as input data, a time-series array of input events from a mouse or a keyboard, for example. The user interface unit uses, as input data, a two-dimensional tensor of pen pressure and coordinates from a stylus pen, for example. The user interface unit uses, as input data, a three-dimensional acceleration vector from a gyro sensor, for example. The user interface unit processes these input data in a local event loop. The user interface unit outputs, as output data, a two-dimensional array of pixel colors drawn on a screen, for example. The user interface unit outputs, as output data, a movement vector of an avatar, for example. The user interface unit outputs, as output data, a serialized command packet transmitted to the server, for example. The user interface unit directly calls a graphics API of the terminal to perform drawing by hardware acceleration. Through this process, the user interface unit realizes smooth screen updating at a high frame rate. The user interface unit prevents screen freezing due to network delay by performing communication with the server asynchronously. Thereby, the user interface unit enhances user immersion and provides intuitive operability. The user interface unit is applied to a collaborative design tool for a multinational designer team. The user interface unit is applied to an interactive blackboard of an international online education platform. The user interface unit is applied to an operation console of a global remote surgery support system.

A database management unit centrally manages and stores user information, configuration information of the virtual space, communication history, project progress data, file sharing data, analysis results by AI, feedback history, questionnaire results, evaluation scores, past project history, various log data, and the like, and enables high-speed search, extraction, and aggregation as necessary. For example, it searches past meeting minutes and chat histories to extract response cases of similar matters, aggregates the contribution degree and utterance tendency of each user to utilize them for human resource evaluation and task assignment, and efficiently provides a large amount of data for progress analysis and risk prediction by AI. Specifically, the database management unit is configured by combining a distributed relational database and a vector database for unstructured data. The database management unit uses, as input data, character string data of a text document, for example. The database management unit uses, as input data, binary data of an image file, for example. The database management unit uses, as input data, structured JSON data of a system log, for example. The database management unit inputs text and image data into an embedding model to convert them into high-dimensional dense vectors. The database management unit indexes and stores the dense vectors in the vector database. The database management unit outputs, as output data, a descending list of cosine similarity scores for a search query, for example. The database management unit outputs, as output data, a set of records matching a specific condition, for example. The database management unit outputs, as output data, a tensor of statistical values calculated by an aggregation function, for example. The database management unit searches for similar data from millions of records in milliseconds using an approximate nearest neighbor search algorithm. Through this process, the database management unit provides context data for retrieval-augmented generation of a large language model at high speed. The database management unit ensures high availability and fault tolerance through data sharding and replication. The database management unit is applied to a company-wide knowledge management system of a multinational company. The database management unit is applied to an international patent search and analysis platform. The database management unit is applied to an integrated search system for global customer response history.

A security management unit performs user authentication, access authority management, communication encryption, data backup, information leakage countermeasures, unauthorized access detection, compliance with personal information protection laws and regulations of each country, audit log management, and the like, and maintains a secure environment that a global multinational team can use with peace of mind. For example, it finely sets access authority for each project to restrict access to specific confidential information and files, detects and blocks unauthorized access and malware attacks from the outside in real time, and automatically optimizes data storage destinations and data transfer routes according to laws and regulations of each country. Specifically, the security management unit functions as an authentication and authorization proxy server based on a zero trust architecture. The security management unit uses, as input data, a multidimensional vector including packet header information of network traffic, for example. The security management unit uses, as input data, an array of timestamps and IP addresses of user login attempts, for example. The security management unit uses, as input data, a tensor of statistical feature quantities extracted from a payload, for example. The security management unit inputs these input data into an autoencoder for anomaly detection. The autoencoder has learned normal communication patterns, and reconstructs the input data after compressing it into a low-dimensional space. The security management unit outputs, as output data, a reconstruction error score between the input data and the reconstructed data, for example. The security management unit outputs, as output data, a binary determination value of permission or rejection for an access request, for example. The security management unit outputs, as output data, a routing tag specifying a data storage destination region, for example. The security management unit automatically disconnects the session when the reconstruction error score exceeds a threshold value. Through this process, the security management unit detects and defends against unknown cyber attacks and internal fraud in real time. The security management unit realizes dynamic data routing compliant with data localization regulations of each country as computer processing. The security management unit is applied to a secure information sharing platform of a multinational financial institution. The security management unit is applied to a joint development network of an international defense industry. The security management unit is applied to a clinical trial data management system of a global pharmaceutical company.

A generative AI cooperation unit receives requests from each unit such as the virtual space generation unit, the communication support unit, and the project progress management unit, generates and transmits an appropriate prompt sentence to the generative AI, and feeds back a response result from the AI to each unit. For example, it generates a prompt “Generate a virtual office space for a multinational team having three bases in Asia, Europe, and North America with a layout reflecting cultural characteristics of each base” from the virtual space generation unit, and transmits it to the AI. In addition, it generates a prompt “Translate ‘Thank you for your consideration’ spoken in Japanese into a casual English expression of American culture” from the communication support unit, and transmits it to the AI. From the project progress management unit, it generates prompts such as “Analyze project progress data and communication history for the past six months, and propose main factors of progress delay and improvement measures” and “Generate a facilitation proposal for mitigating cultural friction between specific members”, and transmits them to the AI. Furthermore, based on feedback and evaluations from users, it also generates prompts such as “Correct this translation result into a more natural expression” and “Summarize minutes of this meeting, and extract action items considering cultural backgrounds of each country”. Specifically, the generative AI cooperation unit functions as an API gateway and a prompt engineering module. The generative AI cooperation unit uses, as input data, key-value pairs of context variables transmitted from each unit, for example. The generative AI cooperation unit uses, as input data, a state vector indicating a current state of a user, for example. The generative AI cooperation unit uses, as input data, a token array of past dialogue history, for example. The generative AI cooperation unit applies these input data to a template engine to dynamically synthesize a structured prompt character string. The generative AI cooperation unit inputs this prompt character string into a tokenizer to convert it into an integer index array. The generative AI cooperation unit outputs, as output data, a token embedding tensor conforming to an input layer of a large language model, for example. The generative AI cooperation unit outputs, as output data, a payload of an HTTP request to an inference server, for example. The generative AI cooperation unit outputs, as output data, extracted text data after parsing a response JSON from the AI, for example. The generative AI cooperation unit performs connection pooling in communication with the inference server to reduce communication overhead. Through this process, the generative AI cooperation unit enables each module in the system to use an advanced inference function without being aware of an internal structure of a complex AI model. The generative AI cooperation unit stabilizes output accuracy of the AI and suppresses hallucination by optimizing prompts. The generative AI cooperation unit is applied to an automatic contract review system of a multinational law firm. The generative AI cooperation unit is applied to a multilingual article automatic generation system of an international news media. The generative AI cooperation unit is applied to an employee engagement analysis system of a global human resources department.

Examples of specific prompt sentences include “Please translate ‘Thank you for your consideration’ spoken in Japanese into a casual English expression of American culture”, “Please convert honorific expressions used in a business meeting of Chinese culture into direct expressions of German culture”, “Please analyze project progress data and meeting logs for the past three months, identify factors of progress delay, and propose three improvement measures”, “Please summarize minutes of this meeting, and extract action items considering cultural backgrounds of each country”, “Please detect signs of cultural friction from a chat history between specific members, and propose mitigation measures”, and “Please generate a virtual office space for a multinational team having three bases in Asia, Europe, and North America with a layout reflecting cultural characteristics of each base”. Specifically, the system internally converts these prompt sentences in natural language into machine-readable vector representations for processing. The system uses, as input data, a character string of raw prompt text, for example. The system uses, as input data, text data of constraint conditions set as a system prompt, for example. The system uses, as input data, a pair array of exemplary data for few-shot learning, for example. The system optimizes these input data using a prompt tuning module. The system outputs, as output data, a soft prompt tensor for guiding an attention mechanism of a large language model to a specific context, for example. The system outputs, as output data, a penalty parameter for controlling a length of generated text, for example. The system outputs, as output data, a numerical value of a temperature parameter for adjusting diversity of output, for example. The system adds these parameters to an inference request and transmits it to the large language model. Through this process, the system realizes mathematical control of context in a high-dimensional space rather than mere passing of character strings. Thereby, the system ensures a stable inference result accurately reflecting human intention as computer technology. The system is applied to automatic response script generation for multinational customer support. The system is applied to qualitative data analysis of international marketing research. The system is applied to multilingual requirement definition document generation in global software development.

As described above, the system according to the present embodiment realizes an advanced virtual office environment in which a global multinational team can smoothly and efficiently collaborate beyond physical, linguistic, and cultural barriers by organically linking the virtual space generation unit, the communication support unit, the project progress management unit, the user interface unit, the database management unit, the security management unit, and the generative AI cooperation unit. Specifically, the system constructs an integrated data processing pipeline in which modules are coupled by a high-speed internal bus and a message queue. The system uses, as input data, multimodal streaming data continuously flowing in from a group of terminals, for example. The system uses, as input data, petabyte-class history data accumulated in a database, for example. The system uses, as input data, a real-time environment variable vector acquired from an external API, for example. The system processes these input data in parallel and in a distributed manner in each module. The system outputs, as output data, a global state matrix of a synchronized virtual space, for example. The system outputs, as output data, a multilingual event stream distributed to terminals of all users, for example. The system outputs, as output data, an aggregation tensor for a dashboard indicating an operating status of the entire system, for example. Through this organic linkage, the system solves complex cross-cultural communication issues that cannot be realized by a single module. The system ensures processing speedup and scalability by replacing translation and facilitation, which are human mental activities, with physical calculation processes of a computer. Thereby, the system provides a next-generation collaboration platform that surpasses conventional video conference systems. The system is applied to an integrated control system of a multinational space development project. The system is applied to a real-time information sharing platform of an international disaster rescue team. The system is applied to a multi-institutional joint simulation environment for global climate change research.

### Implementation Steps

Step 1: User Information Registration and Virtual Space Initialization A user inputs detailed attribute information such as a name, an affiliation, a language used, a cultural background, a time zone, a job title, a field of expertise, a past project participation history, a desired work style, avatar settings, and a preferred interface design from a terminal, and transmits it to the server. The server receives this information and initializes a virtual office space optimized for each user. For example, when having bases in a plurality of regions such as Asia, Europe, North America, South America, Africa, and Oceania, physical position information and network information of each base are integrated, and a metaverse space virtually connecting each base is generated. Various areas such as a conference room, an individual booth, a lounge, a project room, a cafeteria, an event hall, a library, a rest space, a reception area, a whiteboard area, and a presentation room are provided in the virtual space. Specifically, the server encodes user attributes into a multidimensional profile vector in a registration process. The server uses, as input data, a text character string input to a form by a user, for example. The server uses, as input data, an ID of a categorical variable selected from a pull-down menu, for example. The server uses, as input data, a pixel tensor of an uploaded avatar image, for example. The server normalizes and vectorizes these input data by a preprocessing module. The server outputs, as output data, a hash value of a user record stored in a database, for example. The server outputs, as output data, JSON data of a scene graph defining an initial layout of the virtual space, for example. The server outputs, as output data, three-dimensional mesh data indicating an initial state of an avatar, for example. The server minimizes a waiting time at the time of user login by this initialization algorithm. The server realizes personalization while suppressing consumption of calculation resources by combining pre-calculated templates. The server is applied to a virtual office guidance program in an onboarding system of a multinational company. The server is applied to a profile registration system for exhibitors and visitors of an international online exhibition. The server is applied to virtual date space generation of a global matching application.

Step 2: Dynamic Optimization of Virtual Space The server dynamically optimizes a layout, a display language, lighting, background sound, avatar clothing, and the like in the virtual space based on a time zone, a working time zone, a participating project, a job title, a field of expertise, a past activity history, and the like of a user. For example, in a time zone when there are many users in the Asian region, decorations and BGM considering Asian culture are automatically set, and when there are many users in the European region, spatial production tailored to European holidays and events is performed. Specifically, the server executes dynamic updating of environment parameters using a real-time inference engine. The server uses, as input data, a set of profile vectors of all currently logged-in users, for example. The server uses, as input data, numerical data of a current time based on Coordinated Universal Time, for example. The server uses, as input data, a coordinate matrix of each user in the current virtual space, for example. The server inputs these input data into a clustering algorithm to analyze a distribution state of users. The server outputs, as output data, a color vector specifying RGB values of environmental light in the virtual space, for example. The server outputs, as output data, a URI list of audio files of background sound, for example. The server outputs, as output data, a vertex coordinate tensor of a dynamically generated 3D object, for example. The server updates a state machine of the virtual space based on this output result, and push-distributes difference data to each terminal. Through this process, the server avoids re-rendering of the entire space and saves network bandwidth. The server provides an adaptive interface that immediately reacts to a change in a user's situation as computer technology. The server is applied to a dynamic map generation system of a multinational online game. The server is applied to a store layout change system by time zone of an international virtual mall. The server is applied to a virtual floor production system of a global online casino.

Step 3: Multilingual and multicultural communication support. A user uses various communication means such as text chats, voice calls, video conferences, whiteboard sharing, file sharing, and emotional expressions using stamps and emojis in a virtual space. A server translates messages between users into multiple languages in real time using generative AI, and automatically adjusts cultural backgrounds, past communication histories, business manners of each country, religious considerations, gender expressions, switching between honorific and casual expressions, interpretation of humor and irony, meanings of non-verbal expressions, and the like. For example, prompt sentences such as “Please translate ‘Thank you for your consideration’ spoken in Japanese into a casual English expression of American culture” and “Please convert an honorific expression used in a business meeting of Chinese culture into a direct expression of German culture” are transmitted to the generative AI. Specifically, the server executes a streaming translation pipeline at high speed on a memory. The server uses, for example, a stream of text tokens sequentially output from a speech recognition engine as input data. The server uses, for example, a multidimensional vector indicating cultural attributes of a sender and a receiver as input data. The server uses, for example, a context embedding tensor of the latest conversation history as input data. The server inputs these input data to an encoder of a large language model to calculate a latent representation. The server outputs, for example, a text token sequence of a target language as output data. The server outputs, for example, an array of probability scores indicating a certainty factor of translation as output data. The server outputs, for example, an index array indicating highlight positions of words changed by a cultural adaptation process as output data. The server transmits the translation result to each terminal in units of chunks every time the translation result reaches a certain length. By this streaming process, the server displays the translation result without waiting for the end of a sentence, and reduces communication delay to the utmost limit. The server automates complex cultural adaptation, which is impossible on a rule basis, by vector operation in a high-dimensional space. The server is applied to an online support system for multinational diplomatic negotiations. The server is applied to a real-time subtitle generation system of an international news organization. The server is applied to a multilingual simultaneous interpretation platform in global online education.

Step 4: Emotion recognition and visualization of communication. The server analyzes emotional states such as positive, negative, stress, tension, relief, anger, confusion, expectation, joy, disappointment, and fatigue from tones of messages and utterances, facial expressions, gestures, voice intonations, utterance speeds, chat input speeds, use frequencies of emojis and stamps, and the like using an emotion recognition algorithm by generative AI, and visualizes them on a screen of a terminal by icons, color coding, graphs, heat maps, facial expression changes of avatars, and the like. An example of a prompt to the generative AI is “Analyze the emotional state of each participant in chronological order from the chat log and voice data of this meeting, and identify the timing when stress or tension increased.” Specifically, the server integrally analyzes a plurality of sensor data using a multimodal neural network. The server uses, for example, a time-series feature amount matrix of pitch and power extracted from a voice waveform as input data. The server uses, for example, an action unit vector indicating movements of facial expression muscles extracted from a camera image as input data. The server uses, for example, an array of sentiment scores indicating emotional polarities of text as input data. The server inputs these input data to a fusion layer provided with an attention mechanism to dynamically weight the importance of each modality. The server outputs, for example, a softmax vector indicating a probability distribution of ten types of basic emotions as output data. The server outputs, for example, a continuous value score from zero to one hundred indicating a stress level as output data. The server outputs, for example, a tensor of blend shape parameters for controlling facial expressions of avatars as output data. The server stores this output result in a time-series database and transmits it to a drawing engine of each terminal in real time. By this process, the server extracts and visualizes minute non-verbal changes of humans as quantitative data. The server technically prevents miscommunication in online communication by objective quantification of emotions. The server is applied to an online counseling system for multinational mental health care. The server is applied to an evaluation support tool for international personnel interviews. The server is applied to an operator stress management system of a global call center.

Step 5: Facilitation and cultural friction mitigation by AI. The server analyzes the number of utterances, utterance time, diversity of utterance content, the number of reactions to others, and the like of users using generative AI, and automatically generates an utterance promotion message such as “I would also like to hear Mr./Ms. XX's opinion” for a member with few utterances. In addition, when signs of cultural friction are detected, the server presents a facilitation proposal such as “Differences in cultural backgrounds may be affecting the discussion. Let's organize the opinions of each country in order.” An example of a prompt to the generative AI is “Detect signs of cultural friction from meeting logs of the past one month, and propose three mitigation measures.” Specifically, the server executes a natural language processing model. The model adopts a transformer architecture provided with a self-attention mechanism. The server converts voice data of each user into text data. The server converts the text data into a word embedding vector. The server extracts the utterance time and the number of utterances as a numerical vector. The server combines these vectors to generate a multidimensional input tensor. For example, the input tensor is a 512-dimensional floating-point array. The model processes the input tensor. The model outputs a score indicating an occurrence probability of cultural friction. For example, the output is a floating-point number in a range of 0.0 to 1.0. The server determines whether or not the output score exceeds a preset threshold value. The server generates a facilitation message when the threshold value is exceeded. The server transmits the generated message to each terminal. Thereby, the system realizes objective friction detection independent of human subjectivity. The system enables real-time intervention while suppressing wasteful consumption of a communication band. The present technology is applied to an online meeting system for a multinational team.

Step 6: Automatic management of project progress and optimization proposal. The server accumulates activity histories of users in the virtual space, conference participation histories, utterance contents, task completion statuses, file sharing histories, minutes, chat logs, whiteboard writing contents, project milestone achievement statuses, contribution degrees of each user, feedback histories, questionnaire results, evaluation scores, and the like as long-term memory, automatically extracts signs of progress delay and risk factors using generative AI, and performs review of task sharing, proposal of additional resources, automatic reminder of progress reports, automatic generation of progress graphs and Gantt charts, recommendation of leader candidates, and the like. Examples of prompts to the generative AI include “Analyze project progress data and communication histories for the past six months, and propose main factors of progress delay and improvement measures” and “Generate an optimal task assignment plan from the member composition and past contribution degrees of this project.” Specifically, the server executes a recurrent neural network for time-series data analysis. The server converts the activity histories and the task completion statuses into a time-series numerical array. The server converts the minutes in natural language into a sentence embedding vector. The server integrates these data to construct an input tensor. For example, the input tensor is a three-dimensional tensor representing data for the past 30 days. The network processes the input tensor. The network outputs a score vector indicating a delay probability of each task. For example, the output is a delay risk score from 0 to 100 for each task. The server executes a resource reallocation algorithm based on the delay risk scores. The server generates an optimal task assignment plan. The server stores the generated assignment plan in a database. The server transmits a notification signal to a corresponding user terminal. Thereby, the system realizes efficient allocation of computer resources in project management. The system reduces latency of data processing. The present technology is applied to a management tool for a large-scale software development project.

Step 7: Information provision and operation by user interface. On the terminal side, a multilingual and multicultural interface is provided so that a user can intuitively operate an avatar in the virtual space, move to a conference room, a lounge, a whiteboard area, or the like, and perform chats, voice calls, video conferences, file sharing, stamp transmission, questionnaire answering, feedback input, approval/rejection of AI proposals, and the like. For example, when entering a conference room, layout information of the conference room, a participant list, a translated and culturally adapted message history, visualization information of emotional states, a progress graph, a task list, a meeting agenda, a file sharing link, contents of a whiteboard, and the like are transmitted from the server to the terminal, and the terminal displays them in real time. Specifically, the terminal draws a three-dimensional virtual space using a graphics processing unit. The terminal receives the layout information and the participant list from the server. The terminal expands the received data in a local memory. The terminal interprets the visualization information of the emotional states as a color information vector. The terminal executes texture mapping based on the color information vector on a polygon mesh of the avatar. The terminal inputs the translated message history to a text rendering engine. The terminal draws text at designated coordinates on a screen. The terminal detects an input operation from the user as an interrupt signal. The terminal converts the input operation into a command packet. The terminal transmits the command packet to the server by asynchronous communication. Thereby, the system distributes a drawing load on the terminal side. The system minimizes the influence of network delay. The present technology is applied to a multilingual virtual office application.

Step 8: Continuous operation of security, data management, and AI learning. The server performs user authentication, access authority management, communication encryption, data backup, information leakage countermeasures, unauthorized access detection, compliance with personal information protection laws and regulations of each country, audit log management, and the like, and maintains a secure environment that a global multinational team can use with peace of mind. Furthermore, the server collects user feedback and evaluations, and continuously learns and improves translation accuracy, cultural adaptation processes, emotion recognition algorithms, progress analysis algorithms, and the like of generative AI. Examples of prompts to the generative AI include “Please correct this translation result to a more natural expression” and “Please summarize the minutes of this meeting and extract action items considering the cultural backgrounds of each country.” Specifically, the server executes an encryption module. The server applies an advanced encryption algorithm to communication data. The server records an audit log in a database with a hash chain structure. The server executes a machine learning module. The server collects feedback from users as training data. The server inputs feedback text to a natural language processing model. The server updates weight parameters of the model using a backpropagation method. The server calculates a cross-entropy error as a loss function. The server minimizes a value of the loss function by a gradient descent method. The server stores the updated weight parameters in a storage. Thereby, the system continuously improves inference accuracy of the model. The system optimizes calculation costs required for retraining. The present technology is applied to a highly confidential international joint research platform.

### Specific Use Case

For example, assume a case where a global project team having bases in three regions of Asia, Europe, and North America promotes a new product development project. Members of each base have different languages, cultural backgrounds, time zones, and fields of expertise, and the virtual space generation unit receives information such as names, affiliations, languages used, cultural backgrounds, time zones, job titles, fields of expertise, and past project participation histories of each member, and generates a metaverse space virtually connecting the bases in the three regions based on the information. In the virtual space, a dedicated conference room, a breakout room, a lounge, a whiteboard area, a file sharing area, a progress management area, and the like are automatically generated for each project, and each member can freely move to these areas by operating an avatar from a terminal. Specifically, the server executes a space generation algorithm. The server acquires attribute information of each member as structured data. The server converts the attribute information into a feature vector. The server inputs the feature vector to a clustering algorithm. The server calculates a similarity between members. The server determines initial arrangement coordinates in the virtual space based on the similarity. The server measures network delays in the three regions. The server dynamically allocates an edge server based on the delay measurement results. The server generates polygon data and texture data of the virtual space. The server streams the generated data to each terminal. Thereby, the system conceals communication delays caused by physical distances. The system stabilizes a drawing frame rate of the virtual space. The present technology is applied to a virtual headquarters system of a global company.

The communication support unit translates messages into multiple languages in real time using generative AI when each member uses various communication means such as text chats, voice calls, video conferences, whiteboard sharing, and file sharing in a virtual conference room. For example, an expression “Thank you for your consideration” spoken in Japanese is translated into a casual English expression of American culture “Looking forward to your feedback”, and is transmitted to European members with a nuance such as “We are waiting for your opinions.” In addition, the generative AI refers to cultural backgrounds, past communication histories, business manners of each country, religious considerations, switching between honorific and casual expressions, meanings of non-verbal expressions, and the like of each member, and when a member of an Indian cultural sphere says “I will consider it”, for example, the generative AI clarifies the intention and conveys it to North American members as “I'll get back to you soon.” Furthermore, the generative AI analyzes emotional states of each member from tones of messages and utterances, facial expressions, gestures, voice intonations, chat input speeds, use frequencies of emojis and stamps, and the like using an emotion recognition algorithm by the generative AI, and visualizes them on a screen of a terminal by icons, color coding, facial expression changes of avatars, and the like. For example, when stress of some members increases during a meeting, the AI automatically inserts a facilitation message such as “The discussion seems to be heating up. I propose a 5-minute break.” Specifically, the server executes a large language model and an emotion recognition model in parallel. The server converts an input voice stream into an acoustic feature amount tensor. For example, the acoustic feature amount tensor is a two-dimensional array including Mel-frequency cepstral coefficients. The server converts text data into a one-dimensional array of token IDs. The server inputs these tensors to each model. The large language model outputs a token probability distribution according to a translation target language. The emotion recognition model outputs a probability score for each emotion category such as joy and anger. For example, the output is a floating-point vector in which joy is 0.8 and anger is 0.1. The server decodes an optimal word sequence from the probability distribution. The server generates a control parameter of an avatar based on the emotion score. The server synchronizes the translated text and the control parameter and transmits them to the terminal. Thereby, the system prevents a lack of semantic and emotional information transmission between multiple languages. The system maximizes parallel execution efficiency of a processor in real-time processing. The present technology is applied to an international customer support system.

The project progress management unit accumulates conference participation histories, utterance contents, task completion statuses, file sharing histories, minutes, chat logs, whiteboard writing contents, project milestone achievement statuses, contribution degrees of each user, feedback histories, and the like in the virtual space as long-term memory, and automatically extracts signs of progress delay and risk factors using generative AI. For example, when progress is delayed, a prompt “Analyze project progress data and communication histories for the past six months, and propose main factors of progress delay and improvement measures” is transmitted to the generative AI, and the AI proposes specific improvement measures such as “review of task sharing”, “input of additional resources”, and “increase in communication frequency.” In addition, when signs of cultural friction are detected, a prompt “Detect signs of cultural friction from meeting logs of the past one month, and propose three mitigation measures” is transmitted to the generative AI, and facilitation proposals such as “organize opinions of each country in order”, “conduct a vote for consensus building”, and “hold a workshop to share cultural backgrounds” are presented. Specifically, the server executes a graph neural network. The server converts interactions between users into a graph data structure composed of nodes and edges. The server assigns a feature vector such as a task completion rate and an utterance frequency to each node. The server inputs the graph data to the network. The network calculates information propagation between nodes. The network outputs a regression value indicating a delay risk of the entire project. For example, the output is a continuous value in a range of 0 to 1. The server activates an alert generation module when the regression value exceeds a specified threshold value. The server generates specific improvement measure text using the alert generation module. The server writes the generated text in a project management database. Thereby, the system specifies a bottleneck of a task group having complex dependency relationships at an early stage. The system reduces calculation resources required for data search and aggregation. The present technology is applied to a hardware design project by a multinational team.

The user interface unit provides a multilingual and multicultural interface so that a user can intuitively operate an avatar in the virtual space, move to a conference room, a lounge, a whiteboard area, or the like, and perform text chat, voice call, video conference, file sharing, stamp transmission, questionnaire answering, feedback input, approval/rejection of AI proposals, and the like. For example, when entering a conference room, layout information of the conference room, a participant list, a translated and culturally adapted message history, visualization information of an emotional state, a progress graph, a task list, a meeting agenda, a file sharing link, whiteboard contents, and the like are transmitted from the server to the terminal, and the terminal displays them in real time. Specifically, the present terminal executes an event-driven user interface control program. The present terminal monitors an interrupt request from an input device. The present terminal converts a movement operation of the avatar into a displacement vector of three-dimensional coordinates. The present terminal transmits the displacement vector to the server. The present terminal stores the layout information and the participant list received from the server in a local cache memory. The present terminal reads data from the cache memory and transfers it to a screen drawing buffer. The present terminal applies the visualization information of the emotional state as a parameter of a particle system. The present terminal renders the progress graph and the task list as two-dimensional vector graphics. Thereby, the present system optimizes memory usage on the terminal side. The present system reduces processing delay associated with screen redrawing. The present technology is applied to a virtual collaboration tool for remote work.

The database management unit centrally manages and stores user information, configuration information of the virtual space, communication history, project progress data, file sharing data, analysis results by AI, feedback history, questionnaire results, evaluation scores, past project history, various log data, and the like, and enables high-speed search, extraction, and aggregation as necessary. For example, past meeting minutes and chat histories are searched to extract response examples of similar cases, and the degree of contribution and utterance tendency of each user are aggregated and utilized for human resource evaluation and task assignment. Specifically, the present server executes a distributed relational database and a document-oriented database. The present server stores structured data in a table of the relational database. The present server stores chat histories and minutes, which are unstructured data, in the document-oriented database. The present server extracts a keyword vector from text data using a natural language processing model. The present server registers the keyword vector in the database as an inverted index. When receiving a search query, the present server vectorizes the query. The present server calculates a cosine similarity between vectors. The present server extracts data in descending order of similarity. Thereby, the present system dramatically improves a search speed for petabyte-class large-scale data. The present system eliminates an IO bottleneck of storage. The present technology is applied to a knowledge management system of a multinational company.

The security management unit performs user authentication, access authority management, communication encryption, data backup, information leakage countermeasures, unauthorized access detection, compliance with personal information protection laws and regulations of each country, audit log management, and the like, and maintains a secure environment that a global multinational team can use with peace of mind. Specifically, the present server executes an authentication module based on a zero-trust architecture. The present server verifies biometric authentication data and hardware token information transmitted from the user terminal. The present server applies a transport layer security protocol to the entire communication path. The present server executes a machine learning model for anomaly detection. The present server converts an access log into a time-series tensor. The present server inputs the time-series tensor to an autoencoder network. The present network outputs a tensor obtained by reconstructing input data. The present server calculates a reconstruction error between the input tensor and the output tensor. The present server determines that it is an unauthorized access when the reconstruction error exceeds a threshold value. Thereby, the present system improves defense capability against unknown cyber attacks. The present system reduces human costs required for security monitoring. The present technology is applied to an international information sharing platform of a government agency or a financial institution.

The generative AI cooperation unit receives requests from each unit such as the virtual space generation unit, the communication support unit, and the project progress management unit, generates and transmits an appropriate prompt sentence to the generative AI, and feeds back a response result from the AI to each unit. For example, prompt sentences such as “Please translate ‘Thank you for your consideration’ spoken in Japanese into a casual English expression of American culture”, “Please convert an honorific expression used in a business meeting of Chinese culture into a direct expression of German culture”, “Please analyze project progress data and meeting logs for the past three months, identify factors of progress delay, and propose three improvement measures”, “Please summarize the minutes of this meeting and extract action items considering the cultural background of each country”, “Please detect signs of cultural friction from a chat history between specific members and propose mitigation measures”, and “Please generate a virtual office space for a multinational team having three bases in Asia, Europe, and North America with a layout reflecting the cultural characteristics of each base” are transmitted to the generative AI. Specifically, the present server executes a prompt engineering module. The present server receives request data from each unit as structured data in JSON format. The present server parses the structured data and extracts necessary parameters. The present server embeds the extracted parameters into a predefined prompt template. The present server transmits the generated prompt character string to an API endpoint of a large language model. The present server receives a text stream generated from the large language model. The present server analyzes the received text and converts it into a data format for subsequent processing. The present server asynchronously returns the converted data to each requesting unit. Thereby, the present system standardizes an interface between a plurality of modules and the generative AI. The present system minimizes overhead of API calls. The present technology is applied to a microservice architecture that integrates diverse AI services.

Through such use cases, the system of the present invention realizes an environment in which a multinational and multicultural team can smoothly and efficiently collaborate beyond physical, linguistic, and cultural barriers, and is applicable to diverse operations of any multinational and multicultural team, such as global new business development, international research and development, remote work-based startups, large corporations having bases in multiple countries, international freelance groups, international conferences and academic societies, global educational programs, international volunteer activities, cross-border supply chain management, international marketing campaigns, overseas base launch projects, international legal and intellectual property teams, and global customer support centers. Specifically, the present system includes a scalable server group constructed on a cloud computing environment. The present system distributes access requests from all over the world to optimal computing nodes using a load balancer. The present system executes each functional module as an independent container using container orchestration technology. The present system dynamically increases or decreases the number of container replicas according to an increase or decrease in traffic. The present system utilizes edge computing technology to execute data preprocessing at a position close to a user. Thereby, the present system maintains stable service provision even against sudden access concentration. The present system maintains system availability on a global scale at 99.99 percent or more. The present technology is applied to a metaverse platform or an international online event system deployed on a global scale.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment of the present invention, a virtual store operation support system compatible with multinational and multicultural environments is realized by cooperative operation of a server and terminals, assuming extremely specific and diverse usage scenes. Hereinafter, each component, a method of utilizing generative AI, role sharing between the server and the terminals, and further specific usage examples and scenarios will be exhaustively and thoroughly described in detail. Specifically, the present system includes a distributed database and a parallel processing cluster. The present system establishes a bidirectional real-time communication session with a customer terminal and a staff terminal. The present system generates spatial data of a virtual store using a three-dimensional graphics engine. The present system operates a dedicated inference server group hosting a generative AI model. The present inference server group is equipped with a plurality of graphics processing units to accelerate tensor operations. The present system inputs a behavior log and a purchase history of a customer into a stream processing pipeline in real time. Thereby, the present system processes a huge amount of transaction data with low latency. The present system improves customer experience while reducing fixed costs required for physical store operation. The present technology is applied to an e-commerce platform of a retail business expanding globally.

The virtual store space generation unit is realized on the server side. The server receives diverse information such as a language used, a cultural background, a time zone, a purchase history, products of interest, avatar settings, a desired customer service style, an age group, a gender, past feedback, a purchase frequency, a store visit time zone, a preferred payment method, a type of terminal used, and further hobby and preference information through SNS linkage, a past browsing history, friend relationships, and local trend information as attribute information transmitted from terminals of customers and staff, and generates a virtual store space optimized for each user based on the information. For example, when customers from a plurality of regions such as Asia, Europe, North America, South America, Africa, and Oceania visit the store at the same time, external data such as cultural characteristics and national holidays of each region, local trends, seasons, laws and regulations, logistics statuses, exchange rate information, popular product rankings, local event information, region-limited campaigns, local currency display, price display in a local language, local delivery options, and local payment means (electronic payment service, local bank transfer, virtual currency, etc.) are also acquired, and a layout, product display, promotion display, customer service style, event production, product description content, BGM, lighting, avatar clothing, in-store decoration, digital signage, interactive exhibition, hands-on demo booth, popular product corner by region, limited product area, VIP customer exclusive lounge, repeater privilege area, family kids space, barrier-free area, and the like in the virtual space are dynamically optimized. For example, during a time zone when there are many customers in the Asian region, decorations and BGM considering Asian culture and spatial production tailored to local national holidays and events are automatically set, and when there are many customers in the European region, product display and promotion tailored to European trends and seasons are performed. Furthermore, according to the purchase history and products of interest of the customer, a personalized product recommendation area, a privilege area for repeaters, a VIP customer exclusive lounge, a group shopping area for friends, a gift proposal corner, a highly rated review product corner, a sustainable product feature area, a local producer introduction corner, and the like can be automatically generated. Specifically, the present server executes a spatial personalization algorithm. The present server encodes the attribute information of the customer and the external data into a multidimensional feature vector. For example, the feature vector is a 256-dimensional array including numerical values obtained by normalizing the age group and the purchase frequency. The present server inputs the feature vector to a deep reinforcement learning model. The present model outputs an action value function indicating an optimal store layout and product display pattern. For example, the output is an array of expected revenue scores for each layout candidate. The present server selects a layout candidate with the highest score. The present server determines arrangement coordinates and a texture ID of a three-dimensional object based on the selected layout. The present server serializes the determined spatial configuration data and transmits it to the customer terminal. Thereby, the present system dynamically constructs a space that maximizes willingness to buy for each customer. The present system dramatically improves a conversion rate compared to a static web page. The present technology is applied to a personalized virtual shopping mall.

The communication support unit is mainly realized on the server side, but some user interfaces and real-time display processing are also executed on the terminal side. The communication support unit translates messages such as text chats, voice calls, video customer services, whiteboard sharing, file sharing, emotional expressions using stamps and emojis, live streaming, interactive Q&A, product comparison chats, and gesture communication between avatars between customers and staff into multiple languages in real time using generative AI. For example, a question “What material is this product made of?” spoken in Japanese is translated into “What material is this product made of?” for English staff, and further, a Japanese polite expression is adjusted to a direct expression of British culture. Conversely, when an American customer asks “What is the origin of this product?”, an American casual way of asking is converted into a British formal expression while matching the English of the staff. Furthermore, the generative AI refers to the cultural background and past communication history of each user, purchasing trends by country, religious considerations, gender expressions, switching between honorific and casual expressions, meanings of non-verbal expressions, local buzzwords, dialects, slang, industry terms, technical terms, abbreviations, product proper nouns, brand stories, storytelling methods, local advertising expressions, local consumer protection regulations, local ethical norms, local social values, and the like, and for example, converts into an expression reflecting religious considerations for a customer in the Islamic cultural sphere, automatically adjusts to an explanation emphasizing quality and safety for a customer in the Chinese cultural sphere, or converts into an expression emphasizing sustainability and ethical consumption for a customer in the European cultural sphere. The staff receives a question optimized for their own language and culture, and generates an appropriate answer with the support of AI while referring to a product description in the corresponding language from a product description database. For example, when English staff answers “This is made from traditional Japanese materials.”, the AI translates this into Japanese as “This is made from traditional Japanese materials.” and automatically adds a polite expression or honorifics according to Japanese culture. If it is a Chinese customer, it is translated into Chinese, and expressions and emphasis points preferred in Chinese culture (for example, emphasis on quality and safety, fusion of tradition and modernity, consideration for family, and response to gift culture) are automatically added. Furthermore, the AI can automatically generate cross-sell and up-sell proposals at a timing when the customer's willingness to buy increases, and display personalized promotion messages such as “This is also recommended for those who purchased this product”, “There is a discount for set purchases now”, “Gift wrapping is also available”, and “Points will be awarded for posting a review” in real time. Specifically, the present server executes a multilingual transformer model. The present server divides a text message transmitted from the customer terminal into an array of subword tokens. The present server generates a context vector indicating the cultural background and past purchasing trends of the customer. The present server combines the token array and the context vector and inputs them to the model. The present model outputs a token probability distribution of a target language. For example, the output is a time series of probability vectors having dimensions corresponding to a vocabulary size. The present server generates an optimal translated text using a beam search algorithm. The present server transmits the generated text to the staff terminal. The present server executes the same reverse translation process for an answer text from the staff. Thereby, the present system prevents miscommunication due to not only language barriers but also differences in cultural nuances. The present system suppresses calculation delay required for the translation process to a millisecond order. The present technology is applied to a real-time customer service system of a cross-border EC site.

In addition, using an emotion recognition algorithm by generative AI, an emotional state of a customer is multidimensionally analyzed from a tone of a message or utterance, a facial expression, a gesture, voice intonation, a chat input speed, a frequency of use of emojis and stamps, avatar movement, a change in purchasing behavior, a frequency of adding to or deleting from a cart, review posting content, a feedback comment, emotion analysis through SNS linkage, comparison with past purchasing experiences, and the like, and is visualized on a screen of a terminal by an icon, color coding, a change in facial expression of an avatar, an emotion graph, a heat map, a real-time emotion score, a willingness-to-buy indicator, a satisfaction meter, a repeat intention score, a churn risk alert, and the like. For example, when the customer is satisfied with a product description, a “satisfied” icon is displayed, and when there is a question or dissatisfaction, a “question” or “dissatisfied” icon is displayed. The staff can refer to this and perform additional explanation, follow-up, apology, privilege proposal, questionnaire request, review request, revisit promotion message, and the like as necessary. Furthermore, the AI can automatically generate cross-sell and up-sell proposals at a timing when the customer's willingness to buy increases, and display personalized promotion messages such as “This is also recommended for those who purchased this product”, “There is a discount for set purchases now”, “Gift wrapping is also available”, and “Points will be awarded for posting a review” in real time. Specifically, the present server executes a multimodal emotion recognition neural network. The present server extracts facial landmark coordinates from a camera image acquired from the customer terminal. The present server extracts acoustic features such as pitch and energy from voice data. The present server calculates an emotion polarity score from text data. The present server integrates data of these different modalities to generate one feature tensor. For example, the feature tensor is a three-dimensional floating-point array having a time axis. The present network processes the feature tensor and outputs a classification probability of the emotional state. For example, the output is a probability vector in which satisfaction is 0.85 and dissatisfaction is 0.05. The present server generates a display command of an emotion icon based on the probability vector. The present server transmits the display command to the staff terminal. Thereby, the present system accurately grasps a psychological state of a customer in non-face-to-face customer service. The present system improves response quality of staff and maximizes customer satisfaction. The present technology is applied to an online concierge service.

The purchasing behavior analysis unit is mainly realized on the server side. The server accumulates behavior histories of customers in the virtual space (product browsing history, chat history, purchase history, feedback history, questionnaire results, evaluation scores, store visit frequency, stay time, cart addition history, payment method, return history, review posting content, SNS share history, friend invitation history, event participation history, coupon usage history, promotion reaction history, staff response history, transition of popular products, sales fluctuation by season, purchasing trend by region, local economic indicators, local weather information, local traffic information, local logistics status, local law and regulation changes, etc.), past promotion effects, staff response histories, transitions of popular products, sales fluctuations by season, purchasing trends by region, and the like as long-term memory, and multidimensionally and chronologically analyzes these large amounts of data using generative AI. For example, when questions or purchases for a specific product are frequent in a specific cultural sphere, a specific proposal such as “Since this product is highly popular in the Asian region, it is recommended to strengthen promotion for Asian culture” is automatically generated. In addition, advice for improving customer service quality is also provided from the staff response history, such as “Satisfaction improves by increasing more casual expressions for customers in the English-speaking sphere”, “Purchase rate increases by emphasizing explanation of quality assurance for customers in the Chinese-speaking sphere”, and “Repeat rate improves by adding sustainability information for customers in the European sphere”. Furthermore, based on the purchasing behavior and feedback of the customer, the AI performs extraction of popular products, purchasing trend analysis by cultural sphere, optimization proposal of customer service quality, automatic generation of promotion plans, presentation of staff training plans, design of privileges for repeaters, extraction of VIP customers and presentation of special response plans, revisit promotion measures for churn risk customers, cart abandonment countermeasures, return prevention measures, review promotion measures, SNS diffusion promotion measures, friend invitation campaign design, event participation promotion measures, local event-linked promotions, customer response plans at the time of local logistics delay, sales strategy adjustment plans at the time of local law and regulation changes, and the like. For example, it is also possible to extract products that customers in the Asian region were interested in and reasons thereof from chat histories for the past one month and propose three promotion plans, or to analyze expression patterns with high satisfaction from staff answer histories to customer questions and utilize them for staff training. Specifically, the present server executes a time-series prediction model and a clustering algorithm. The present server converts the behavior history of the customer and external factor data into a time-series multidimensional tensor. The present server inputs the multidimensional tensor to a long short-term memory network. The present network outputs a prediction score indicating a future purchase probability or churn risk. For example, the output is a churn probability value in a range of 0 to 1 for each customer. The present server classifies customers into a plurality of segments based on the prediction score. The present server determines an optimal promotion measure for each segment. The present server registers the determined measure in a promotion distribution engine. The present server analyzes the staff response history using a natural language processing model and calculates an evaluation score of customer service skills. Thereby, the present system automates a data-driven marketing strategy. The present system significantly reduces analysis man-hours of a person in charge of marketing. The present technology is applied to a large-scale customer relationship management system.

On the terminal side, it is responsible for displaying a user interface, receiving input from a user, displaying translation results and emotion analysis results in real time, operating an avatar in the virtual space, browsing products, operating a cart, processing payment, posting reviews, inputting feedback, approving/rejecting AI proposals, inviting friends, sharing on SNS, acquiring coupons, participating in events, answering questionnaires, viewing promotional videos, participating in live streaming, experiencing interactive exhibitions, virtual fitting, virtual tasting, virtual hands-on demonstrations, switching local currency display, selecting local delivery options, selecting local payment methods, barrier-free settings, kids mode settings, privacy mode settings, and the like. For example, when a customer enters a virtual store from a terminal, store layout information and a product list optimized for the customer, translated and culturally adapted product descriptions, visualization information of an emotional state, promotion information, messages from staff, purchase history, privilege information, store visit statuses of friends, event holding information, review rankings, an SNS share button, a coupon acquisition button, a questionnaire answer button, a live streaming participation button, a virtual fitting button, and the like are transmitted from the server to the terminal, and the terminal displays these in real time. When the customer asks a question about a product, the terminal transmits the content to the server, and after the generative AI on the server side performs translation, a cultural adaptation process, and an emotion recognition process, a message optimized for a staff terminal is distributed. When the staff answers, the content is similarly optimized for the customer terminal and returned. When the customer writes a memo on a whiteboard, the content is also automatically translated into multiple languages, enabling staff in each country to understand it in their own language. Specifically, the present terminal executes three-dimensional rendering by utilizing a local graphics processing unit. The present terminal maps the store layout information and the product list received from the server to a data structure on a memory. The present terminal updates a camera matrix according to a movement of a viewpoint of the user. The present terminal projects a three-dimensional object onto a two-dimensional screen using the camera matrix. The present terminal displays the translated product description text as an overlay on a UI layer. The present terminal captures a tap or swipe operation of the user with an event listener. The present terminal converts the captured event into a request payload for the server. The present terminal transmits the request payload to the server by secure WebSocket communication. Thereby, the present system completely offloads a drawing load on the server side. The present system provides a smooth operation experience without delay to the user. The present technology is applied to a virtual reality shopping application for smartphones.

In addition, the generative AI also learns user behavior patterns and purchasing trends, feedback, external trend information, national holidays and event information of each country, laws and regulations, logistics statuses, exchange rate fluctuations, local weather, local traffic, local social situations, local consumer protection regulations, local advertising regulations, local ethical norms, local social values, trends of local consumer groups, trends of local competing stores, trends of local influencers, local SNS trends, evaluations on local word-of-mouth sites, evaluations on local review sites, topics on local news sites, search trends on local search engines, popular videos on local video distribution services, popular music on local music distribution services, popular books on local e-book services, popular games on local game distribution services, and the like, and contributes to optimization of the entire system. For example, it is also possible to learn a tendency that purchasing becomes active in a specific time zone, and the AI automatically proposes scheduling of important promotions and events, automatically adjusts promotion content in consideration of national holidays and large-scale events of each country, predicts risks of exchange rate fluctuations and logistics delays to present a sales strategy, automatically adjusts a sales strategy and product descriptions according to local social situations and changes in laws and regulations, and analyzes trends of local competing stores and content transmitted by influencers to optimize a promotion strategy. Furthermore, the AI collects feedback and evaluations from customers and staff, and continuously learns and improves translation accuracy, the cultural adaptation process, the emotion recognition algorithm, a purchasing behavior analysis algorithm, a promotion optimization algorithm, a staff education algorithm, a repeater development algorithm, a VIP customer extraction algorithm, a churn risk prediction algorithm, a cart abandonment countermeasure algorithm, a return prevention algorithm, a review promotion algorithm, an SNS diffusion promotion algorithm, a friend invitation promotion algorithm, an event participation promotion algorithm, a local event-linked promotion algorithm, a customer response algorithm at the time of local logistics delay, a sales strategy adjustment algorithm at the time of local law and regulation change, and the like. For example, when a customer inputs feedback such as “this translation was unnatural,” “this product description is difficult to convey its appeal in my own culture,” “this AI proposal does not match the actual situation on site,” “this promotion does not match local trends,” or “this staff's response is contrary to local manners,” the AI learns the content and reflects it in subsequent translations, proposals, promotions, staff education, and store operations. Specifically, the present server executes a continuous learning pipeline. The present server periodically crawls trend information and law and regulation data through an external API. The present server analyzes the collected text data with a natural language processing model to construct a knowledge graph. The present server adds a relationship vector extracted from the knowledge graph to a data set for fine-tuning of the generative AI. The present server inputs feedback text from customers and staff as a reward signal to a reinforcement learning algorithm. The present server updates parameters of the model using a proximal policy optimization algorithm. The present server tests and evaluates the updated model in a shadow environment. The present server seamlessly replaces the model in a production environment when an evaluation score satisfies a standard. Thereby, the present system autonomously maintains an adaptive capability of the model to environmental changes. The present system prevents obsolescence of the model and guarantees long-term inference accuracy. The present technology is applied to an autonomously evolving store operation automation platform.

As described above, in the embodiment of the present invention, the functions of the virtual store space generation unit, the communication support unit, and the purchasing behavior analysis unit are mainly realized on the server side, and the terminal side is made to be responsible for a user interface, real-time display processing, user input reception, local optimization processing, promotion display, event participation, review posting, SNS sharing, friend invitation, coupon acquisition, questionnaire answering, live streaming participation, virtual fitting, virtual hands-on demonstrations, local currency display switching, local delivery option selection, local payment method selection, barrier-free settings, kids mode settings, privacy mode settings, and the like, thereby providing an advanced multinational and multicultural virtual store operation support environment with the generative AI as a core. For example, in any multinational and multicultural virtual store, such as a virtual store of a global fashion brand, an online showroom of an international home appliance manufacturer, a virtual tasting event of a multinational food company, a virtual exhibition targeting customers around the world, a cross-border e-commerce platform, virtual teaching material sales of an international educational institution, a virtual auction of a global art gallery, a virtual experience service of an international tourist information center, local traditional craft sales, local agricultural product direct sales, local tourist souvenir sales, local artist work sales, local event-linked limited product sales, local social contribution type product sales, local sustainable product features, local fair trade product features, local regional revitalization project-linked sales, local crowdfunding-linked sales, local community-linked sales, local educational institution-linked teaching material sales, local medical institution-linked health product sales, and local government-linked specialty product sales, it is possible to realize an efficient and smooth customer service and purchasing experience beyond physical, linguistic, cultural, social, economic, and legal barriers. Furthermore, by automatic learning and optimization by the AI, the system continuously evolves, and it becomes possible to continue to flexibly respond to diverse needs of users, changes in the global environment, changes in local society, changes in the local economy, changes in local laws and regulations, changes in local trends, changes in values of local consumers, changes in trends of local competitors, changes in trends of local influencers, changes in local SNS trends, changes in evaluations on local word-of-mouth sites, changes in evaluations on local review sites, changes in topics on local news sites, changes in search trends on local search engines, changes in popular videos on local video distribution services, changes in popular music on local music distribution services, changes in popular books on local e-book services, changes in popular games on local game distribution services, and the like. Specifically, the present system adopts a microservices architecture and deploys each function as an independent service group. The present system controls and monitors communication traffic between the respective services using a service mesh technology. The present system executes an edge AI model on the terminal side and completes a part of inference processing locally. The present system executes large-scale batch processing and real-time stream processing in parallel on the server side. The present system periodically converts and loads unstructured data accumulated in a data lake into a data warehouse. The present system cooperates with a business intelligence tool to generate a dashboard of an operation status. Thereby, the present system enhances fault tolerance and scalability of the entire system to the utmost limit. The present system clears complex data governance requirements accompanying multinational expansion. The present technology is applied to a next-generation global metaverse commerce infrastructure.

### System Configuration

The system according to the present embodiment comprises a virtual store space generation unit, a communication support unit, a purchasing behavior analysis unit, a user interface unit, a database management unit, a security management unit, and a generative AI cooperation unit. The virtual store space generation unit receives diverse information such as a language used, a cultural background, a time zone, a purchase history, products of interest, avatar settings, a desired customer service style, an age group, a gender, past feedback, a purchase frequency, a store visit time zone, a preferred payment method, a used terminal type, hobby and preference information by SNS cooperation, a past browsing history, friend relationships, and local trend information transmitted from terminals of customers and staff, and generates a virtual store space optimized for each user based on the information. For example, when customers in a plurality of regions such as Asia, Europe, North America, South America, Africa, and Oceania visit the store at the same time, external data such as cultural characteristics and national holidays of each region, local trends, seasons, laws and regulations, logistics statuses, exchange rate information, popular product rankings, local event information, region-limited campaigns, local currency display, price display in local languages, local delivery options, and local payment means are also acquired, and a layout, product display, promotion display, customer service style, event production, product description content, BGM, lighting, avatar clothing, in-store decoration, digital signage, interactive exhibitions, hands-on demonstration booths, popular product corners by region, limited product areas, VIP customer exclusive lounges, privilege areas for repeaters, kids spaces for families, barrier-free compatible areas, and the like in the virtual space are dynamically optimized. For example, in a time zone when there are many customers in the Asian region, decorations and BGM considering Asian culture, and spatial production tailored to local national holidays and events are automatically set, and when there are many customers in the European region, product display and promotions tailored to European trends and seasons are performed. Furthermore, according to the purchase history and products of interest of the customer, a personalized product recommendation area, a privilege area for repeaters, a VIP customer exclusive lounge, a group shopping area for friends, a gift proposal corner, a high review evaluation product corner, a sustainable product feature area, a local producer introduction corner, and the like can also be automatically generated. Specifically, the present virtual store space generation unit is executed on a parallel computing cluster composed of a plurality of computing nodes. The present virtual store space generation unit maps the diverse attribute information received from the customer terminal to a high-dimensional vector space. The present virtual store space generation unit converts text information into an embedding vector using a natural language processing model. The present virtual store space generation unit normalizes numerical data such as the purchase history and the store visit time zone to generate a numerical vector. The present virtual store space generation unit combines these vectors to construct an input tensor. For example, the present input tensor includes a one-dimensional array indicating the age group of the customer, a time-series array indicating the past purchase history, and an embedding vector of a categorical variable indicating the cultural background. The present virtual store space generation unit inputs this input tensor to a graph neural network. The present graph neural network learns a graph structure expressing friend relationships between customers and local trend information by nodes and edges. The present graph neural network updates a feature amount of each node and outputs a spatial optimization parameter for each customer. The present output data includes a three-dimensional floating-point tensor indicating layout coordinates in the virtual space, and a set of scalar values indicating brightness of lighting and volume of BGM. The present virtual store space generation unit transmits a drawing command to a rendering engine based on this output data. By this process, the present system eliminates layout changes by human manual work. The present system completes dynamic generation of a space according to the attributes of the customer in units of milliseconds. As a technical effect, the present system realizes an extension of a stay time of the customer and an improvement in willingness to buy by providing a personalized space. As a specific application field, the present system is applied to an application of automating product display adapted to culture of each region in a virtual flagship store of an apparel brand expanding multinationally.

The communication support unit translates messages such as text chats, voice calls, video customer services, whiteboard sharing, file sharing, emotional expressions using stamps and emojis, live streaming, interactive Q&A, product comparison chats, and gesture communication between avatars between customers and staff into multiple languages in real time using generative AI. For example, a question “What material is this product made of?” spoken in Japanese is translated into “What material is this product made of?” for English staff, and further, a Japanese polite expression is adjusted to a direct expression of British culture. Conversely, when an American customer asks “What is the origin of this product?”, an American casual way of asking is converted into a British formal expression while matching the English of the staff. Furthermore, the generative AI refers to the cultural background and past communication history of each user, purchasing trends by country, religious considerations, gender expressions, switching between honorific and casual expressions, meanings of non-verbal expressions, local buzzwords, dialects, slang, industry terms, technical terms, abbreviations, product proper nouns, brand stories, storytelling methods, local advertising expressions, local consumer protection regulations, local ethical norms, local social values, and the like, and for example, converts into expressions reflecting religious considerations for customers in the Islamic cultural sphere, automatically adjusts to explanations emphasizing quality and safety for customers in the Chinese cultural sphere, and converts into expressions emphasizing sustainability and ethical consumption for customers in the European cultural sphere. The staff receives a question optimized for their own language and culture, and generates an appropriate answer with the support of the AI while referring to a product description in the corresponding language from a product description database. For example, when the English staff answers “This is made from traditional Japanese materials.”, the AI translates this into Japanese as “This is made from traditional Japanese materials”, and automatically adds polite expressions and honorifics in accordance with Japanese culture. If it is a Chinese customer, it is translated into Chinese, and expressions and emphasis points preferred in Chinese culture are automatically added. Furthermore, the AI automatically generates cross-sell and up-sell proposals at a timing when the customer's willingness to buy increases, and can also display personalized promotion messages such as “This is also recommended for those who purchased this product,” “There is a discount for set purchases now,” “Gift wrapping is also available,” and “Points awarded for posting a review” in real time. In addition, using an emotion recognition algorithm by the generative AI, the emotional state of the customer is multidimensionally analyzed from tones of messages and utterances, facial expressions, gestures, voice intonations, chat input speeds, usage frequencies of emojis and stamps, avatar movements, changes in purchasing behavior, frequencies of cart additions and deletions, review posting content, feedback comments, emotion analysis by SNS cooperation, comparisons with past purchasing experiences, and the like, and visualized on the screen of the terminal by icons, color coding, avatar facial expression changes, emotion graphs, heat maps, real-time emotion scores, willingness to buy indicators, satisfaction meters, repeat intention scores, churn risk alerts, and the like. The staff can refer to this and perform additional explanations, follow-ups, apologies, privilege proposals, questionnaire requests, review requests, revisit promotion messages, and the like as necessary. Specifically, the present communication support unit operates on an inference server hosting a large language model equipped with a self-attention mechanism. The present communication support unit divides input text of the customer into a token sequence by a tokenizer. The present communication support unit generates a context vector indicating the cultural background and past purchasing trends of the customer. The present communication support unit combines the token sequence and the context vector, and inputs them to the large language model. For example, the present input data includes a token sequence of Japanese question text, a categorical vector indicating the nationality of the customer, and a flag value indicating a past claim history. The present large language model adopts a transformer architecture having billions of parameters. The present large language model calculates a dependency relationship between each element of the input token sequence. The present large language model outputs a probability distribution of a token sequence of a target language. The present output data includes character string data indicating translated text, and a floating-point array indicating a selection certainty factor of each word. Furthermore, the present communication support unit executes a multimodal emotion recognition model. The present emotion recognition model receives an acoustic feature amount tensor including a mel-frequency cepstrum coefficient of voice data of the customer and an image tensor indicating a facial expression change of the avatar as inputs. The present emotion recognition model extracts an image feature amount using a convolutional neural network. The present emotion recognition model processes a time-series acoustic feature amount using a recurrent neural network. The present emotion recognition model outputs an emotion score vector indicating a probability distribution of basic emotions such as joy, anger, and sadness. When this emotion score vector exceeds a predetermined threshold, the present communication support unit transmits a trigger signal to a subsequent promotion generation module. By this process, the present system executes not a mere literal translation but a free translation considering the cultural background in real time. As a technical effect, the present system reduces communication errors between different cultures and improves customer satisfaction. As a specific application field, the present system is applied to a task of responding to inquiries from customers speaking diverse languages with a small number of specialized staff in a global customer support center.

The purchasing behavior analysis unit accumulates behavior histories of customers in the virtual space (product browsing history, chat history, purchase history, feedback history, questionnaire results, evaluation scores, store visit frequency, stay time, cart addition history, payment method, return history, review posting content, SNS share history, friend invitation history, event participation history, coupon usage history, promotion reaction history, staff response history, transition of popular products, sales fluctuation by season, purchasing trend by region, local economic indicators, local weather information, local traffic information, local logistics status, local law and regulation change, etc.), past promotion effects, staff response histories, transitions of popular products, sales fluctuations by season, purchasing trends by region, and the like as long-term memory, and multidimensionally and time-serially analyzes these large amounts of data using generative AI. For example, when questions and purchases for a specific product are frequent in a specific cultural sphere, a specific proposal such as “Since this product is highly popular in the Asian region, it is recommended to strengthen promotions for Asian culture” is automatically generated. In addition, advice for improving customer service quality is also provided from the staff response history, such as “Satisfaction improves by increasing more casual expressions for customers in the English-speaking sphere,” “Purchasing rate increases by emphasizing explanations of quality assurance for customers in the Chinese-speaking sphere,” and “Repeat rate improves by adding sustainability information for customers in the European sphere.” Furthermore, based on the purchasing behavior and feedback of the customers, the AI performs extraction of popular products, purchasing trend analysis by cultural sphere, optimization proposals for customer service quality, automatic generation of promotion plans, presentation of staff education plans, design of privileges for repeaters, extraction of VIP customers and presentation of special response plans, revisit promotion measures for churn risk customers, cart abandonment countermeasures, return prevention measures, review promotion measures, SNS diffusion promotion measures, friend invitation campaign design, event participation promotion measures, local event-linked promotions, customer response plans at the time of local logistics delay, sales strategy adjustment plans at the time of local law and regulation change, and the like. Specifically, the present purchasing behavior analysis unit operates in cooperation with a distributed database system. The present purchasing behavior analysis unit constructs the behavior history of the customer as a time-series tensor. The present time-series tensor includes a timestamp of product browsing, a numerical value of stay time in units of milliseconds, and a binary value indicating presence or absence of cart addition. The present purchasing behavior analysis unit inputs this time-series tensor to a long short-term memory network. The present long short-term memory network learns a long-term dependency relationship of past behavior patterns. The present long short-term memory network outputs a score indicating a future purchasing probability of the customer. For example, the present output data includes a floating-point number from 0 to 1 indicating a purchasing probability for a specific product category, and a percentage value indicating a churn risk. The present purchasing behavior analysis unit clusters customers into a plurality of segments based on this output score. The present purchasing behavior analysis unit inputs a clustering result to a reinforcement learning model. The present reinforcement learning model searches for an optimal promotion measure based on a Markov decision process. The present reinforcement learning model uses a past promotion reaction history as a reward function. The present reinforcement learning model maximizes an action value function indicating an optimal discount rate and proposal timing for each customer segment. The present purchasing behavior analysis unit generates specific promotion text based on an output of the reinforcement learning model. By this process, the present system eliminates analysis based on rules of thumb by human marketers. The present system automatically extracts non-trivial purchasing patterns from high-dimensional behavior data. As a technical effect, the present system improves a conversion rate of promotions and prevents a decrease in profit margin due to useless discounts. As a specific application field, the present system is applied to dynamic pricing linked to seasonal fluctuations and economic indicators by region and automatic execution of sales promotion campaigns in a cross-border e-commerce platform.

The user interface unit provides a multilingual and multicultural interface so that customers and staff can intuitively operate avatars in the virtual space, and perform product browsing, cart operations, payment processing, review posting, feedback input, approval/rejection of AI proposals, friend invitations, SNS sharing, coupon acquisition, event participation, questionnaire answering, promotional video viewing, live streaming participation, interactive exhibition experiences, virtual fitting, virtual tasting, virtual hands-on demonstrations, local currency display switching, local delivery option selection, local payment method selection, barrier-free settings, kids mode settings, privacy mode settings, and the like. For example, when a customer enters a virtual store from a terminal, store layout information and a product list optimized for the customer, translated and culturally adapted product descriptions, visualization information of an emotional state, promotion information, messages from staff, purchase history, privilege information, store visit statuses of friends, event holding information, review rankings, an SNS share button, a coupon acquisition button, a questionnaire answer button, a live streaming participation button, a virtual fitting button, and the like are transmitted from the server to the terminal, and the terminal displays these in real time. Specifically, the present user interface unit executes drawing processing by utilizing a graphics processing unit of the customer terminal. The present user interface unit parses three-dimensional coordinate data of the store layout information and the product list received from the server. The present user interface unit transfers these data to a graphics memory as a vertex buffer object. The present user interface unit renders a polygon model of the virtual space in real time using a vertex shader and a fragment shader. The present user interface unit converts an emotion score vector received from the server into a color map as visualization information of the emotional state. The present user interface unit dynamically applies this color map to a texture of the avatar. For example, the present user interface unit draws an integer value from 0 to 100 as a width of a progress bar as a willingness to buy indicator. The present user interface unit captures an input operation from the customer by an event listener. The present user interface unit generates an event object including a type of the input operation and a timestamp. The present user interface unit transmits this event object to the server using an asynchronous communication protocol. By this process, the present system reduces a drawing load on the server side and realizes a low-latency interface operation on the terminal side. As a technical effect, the present system provides a smooth virtual space experience even in an environment with large network delay, and prevents customer churn. As a specific application field, the present system is applied to a mobile commerce application for experiencing high-quality virtual fitting and interactive exhibitions using a device with limited computing resources such as a smartphone or a tablet terminal.

The database management unit centrally manages and stores user information, configuration information of the virtual space, communication histories, purchasing behavior data, product information, promotion histories, feedback histories, questionnaire results, evaluation scores, past project histories, various log data, and the like, and enables high-speed retrieval, extraction, and aggregation as necessary. For example, past meeting minutes and chat histories are retrieved to extract response examples of similar cases, contribution degrees and utterance tendencies of each user are aggregated to be utilized for human resource evaluation and task assignment, and large amounts of data for progress analysis and risk prediction by AI are efficiently provided. Specifically, the present database management unit adopts a hybrid storage architecture integrating a distributed key-value store and a vector database. The present database management unit stores structured data such as user information and purchasing behavior data in a relational database. The present database management unit converts unstructured data such as chat histories and product descriptions into high-dimensional embedding vectors by a natural language processing model. The present database management unit indexes and stores this embedding vector in the vector database. For example, the present database management unit converts text of past meeting minutes into a 768-dimensional floating-point array. When a search query is input, the present database management unit similarly converts the query into an embedding vector. The present database management unit calculates a cosine similarity between the query vector and vectors in the database. The present database management unit extracts data having a similarity exceeding a predetermined threshold at high speed. The present database management unit provides the extracted data to a subsequent generative AI cooperation unit. By this process, the present system extracts semantically similar past response examples that cannot be found by a simple keyword match search. As a technical effect, the present system shortens search latency for a large-scale data set to the order of milliseconds, and enables real-time information provision. As a specific application field, the present system is applied to a knowledge management system that instantly draws out an optimal response pattern from a huge amount of past customer service logs and supports tasks of new staff in a global retail company possessing customer data of millions of people.

The security management unit performs user authentication, access authority management, communication encryption, data backup, information leakage countermeasures, unauthorized access detection, compliance with personal information protection laws and regulations of each country, audit log management, and the like, and maintains a secure environment that a global multinational team can use with peace of mind. For example, access authority is finely set for each project to restrict access to specific confidential information and files, unauthorized access and malware attacks from the outside are detected and blocked in real time, and data storage destinations and data transfer routes are automatically optimized according to laws and regulations of each country. Specifically, the present security management unit implements an access control mechanism based on a zero trust network architecture. The present security management unit processes a multi-factor authentication request including biometric authentication data and a hardware fingerprint of a terminal in addition to password authentication at the time of a login attempt of a user. The present security management unit encrypts all packets exchanged on a communication path using an advanced encryption standard algorithm. The present security management unit collects log data of network traffic in real time and inputs it to an anomaly detection model. The present anomaly detection model adopts an autoencoder-type neural network. The present anomaly detection model learns a feature amount tensor of a normal communication pattern. For example, the present input data is a multidimensional numerical array including a source IP address, a port number, a packet size, and a communication frequency. The present anomaly detection model compresses the input feature amount tensor into a low-dimensional latent space, and restores it to the original dimension again. The present anomaly detection model calculates a reconstruction error between the input tensor and the restored tensor. When this reconstruction error exceeds a dynamically set threshold, the present security management unit determines the communication as unauthorized access. The present security management unit immediately disconnects a session determined as unauthorized access, and transmits an alert to an administrator. By this process, the present system autonomously defends against unknown cyber attacks that cannot be handled by known signature-based detection. As a technical effect, the present system minimizes an information leakage risk in global data transfer, and ensures compliance with strict data protection regulations of each country. As a specific application field, the present system is applied as a secure data linkage infrastructure across borders in a cross-border e-commerce platform handling credit card information and detailed purchase histories of customers.

The generative AI linkage unit receives requests from each unit such as the virtual store space generation unit, the communication support unit, and the purchasing behavior analysis unit, generates and transmits an appropriate prompt sentence to the generative AI, and feeds back a response result from the AI to each unit. For example, the generative AI linkage unit transmits prompt sentences to the generative AI, such as “Please translate ‘What material is this product made of?’ spoken in Japanese into a formal English expression of British culture,” “Please extract products that customers in the Asian region were interested in and the reasons therefor from the chat history of the past month, and propose three promotion plans,” “Please analyze expression patterns with high satisfaction from the response history of the staff to customer questions,” “Please convert this product description into an expression emphasizing quality and safety for customers in the Chinese cultural sphere,” “Please generate three privilege plans for promoting repeat purchases from the purchasing behavior and feedback of this customer,” “Please generate a product description text corresponding to a change in local laws and regulations,” and “Please generate a response plan for maintaining customer satisfaction at the time of a local logistics delay.” Specifically, the generative AI linkage unit functions as an API gateway in a microservice architecture. The generative AI linkage unit temporarily stores request messages asynchronously transmitted from each unit in a message queue. The generative AI linkage unit selects an appropriate prompt template according to the priority and type of the request. The generative AI linkage unit inserts context data included in the request into a variable part of the prompt template, and dynamically generates a final prompt character string. The generative AI linkage unit transmits the generated prompt character string to an inference endpoint of a natural language processing model as an HTTP request. For example, the generative AI linkage unit constructs a payload including a text array of the customer's chat history and a JSON schema definition specifying a requested output format as input data. The inference endpoint executes a large language model and generates a response text to the prompt. The generative AI linkage unit parses the response text received from the inference endpoint and verifies whether it conforms to the specified JSON schema. The generative AI linkage unit returns the response data that has passed the verification to the original request transmission source module via a callback function. By this process, the system efficiently schedules simultaneous and multiple AI inference requests from a plurality of modules. As a technical effect, the system prevents depletion of computational resources of the inference server and maximizes the processing throughput of the entire system. As a specific application field, the system is applied to a back-end system that processes personalized message generation for each customer without delay in a large-scale virtual event accessed by thousands of customers simultaneously.

In this way, the system according to the present embodiment organically links the virtual store space generation unit, the communication support unit, the purchasing behavior analysis unit, the user interface unit, the database management unit, the security management unit, and the generative AI linkage unit, thereby realizing an efficient and smooth customer service and purchasing experience beyond physical, linguistic, cultural, social, economic, and legal barriers in a global multinational and multicultural virtual store. Specifically, the system executes each of the above-described units as a containerized independent process, and integrally manages them on a cluster using an orchestration tool. The system synchronizes three-dimensional space data constructed by the virtual store space generation unit and translated text data generated by the communication support unit at high speed via a shared memory space. The system dynamically injects a purchase probability score of the customer output by the purchasing behavior analysis unit as a context of the prompt via the generative AI linkage unit. The system asynchronously executes these linkage processes based on an event-driven architecture. For example, the system constructs a series of pipelines in which an inference request is transmitted to the purchasing behavior analysis unit triggered by an avatar's motion event of the customer picking up a specific product, and the communication support unit presents customer service advice to the staff based on the result. By this process, the system forms a feedback loop in which each functional module does not operate independently but uses mutual output data as input. As a technical effect, the system allows the entire system to immediately adapt to minute behavioral changes of the customer, and provides a consistent and advanced customer service experience. As a specific application field, the system is applied as an integrated platform that realizes advanced personalization as if an exclusive concierge is attached to each customer in a metaverse store of a high-end brand aiming to surpass the customer service quality of a real store.

### Implementation Steps

Step 1: Registration of User Attribute Information and Initialization of Virtual Store Space Customers and staff input various attribute information such as a language used, a cultural background, a time zone, a purchase history, products of interest, avatar settings, a desired customer service style, an age group, a gender, past feedback, a purchase frequency, a store visit time zone, a preferred settlement method, a used terminal type, hobby and preference information by SNS linkage, a past browsing history, friend relationships, and local trend information from terminals, and transmit them to the server. The server receives these pieces of information and initializes a virtual store space optimized for each user. For example, when customers in a plurality of regions such as Asia, Europe, and North America visit the store simultaneously, external data such as cultural characteristics and national holidays of each region, local trends, seasons, laws and regulations, logistics statuses, exchange rate information, popular product rankings, local event information, region-limited campaigns, local currency display, price display in local languages, local delivery options, and local payment means are also acquired, and a layout, product display, promotion display, customer service style, event production, product description content, BGM, lighting, avatar clothing, in-store decoration, and the like in the virtual space are dynamically optimized. Specifically, the server receives a payload in a JSON format including the attribute information transmitted from the customer terminal. The server parses each attribute value in the received payload and inputs it to a feature amount extraction module. The feature amount extraction module converts a categorical variable into a binary vector by one-hot encoding. The feature amount extraction module normalizes a continuous variable by min-max scaling and generates a floating-point vector. The server combines these vectors to construct a customer-specific profile tensor. For example, the profile tensor includes a 5-dimensional binary array indicating the age group and a 1-dimensional normalized numerical value indicating the past purchase amount. The server inputs this profile tensor to a space generation neural network. The space generation neural network converts the profile tensor into a representation vector of a latent space using a multilayer perceptron. The space generation neural network outputs a set of transformation matrices indicating arrangement coordinates, a scale, and a rotation angle of each object constituting the virtual space based on this representation vector. The server acquires an environment data vector including local weather information and exchange rate information via an external API, and combines it with the representation vector to determine a final space layout. By this process, the system dynamically synthesizes a space having an infinite number of variations according to a combination of the customer's attributes and the external environment, rather than selecting a static template. As a technical effect, the system instantaneously provides a highly immersive virtual environment that perfectly matches the customer's cultural background and current situation, and dramatically increases initial engagement. As a specific application field, the system is applied to a use of automatically constructing a dedicated exhibition booth tailored to the area of interest of each visitor and the culture of their home country in an international online exhibition accessed by diverse customers around the world.

Step 2: Multilingual and Multicultural Communication Support The customers and the staff use various communication means such as text chats, voice calls, video customer service, whiteboard sharing, file sharing, emotional expressions using stamps and emojis, live streaming, interactive Q&A, product comparison chats, and gesture communication between avatars in the virtual space. The server translates messages between the customers and the staff into multiple languages in real time using generative AI, and automatically performs a cultural adaptation process by referring to the cultural background and past communication history of each user, purchasing trends by country, religious considerations, gender expressions, switching between honorific and casual expressions, meanings of non-verbal expressions, local buzzwords, dialects, slang, industry terms, technical terms, abbreviations, product proper nouns, brand stories, storytelling methods, local advertising expressions, local consumer protection regulations, local ethical norms, local social values, and the like. Examples of prompts to the generative AI include “Please translate ‘What material is this product made of?’ spoken in Japanese into a formal English expression of British culture,” “Please convert this product description into an expression emphasizing quality and safety for customers in the Chinese cultural sphere,” and the like. Specifically, the server inputs voice data streaming-received from the customer terminal to a voice recognition engine, and converts it into a text token sequence. The server combines this text token sequence and a culture code vector extracted from the customer's profile tensor, and inputs them to a translation transformer model. The translation transformer model includes an encoder-decoder architecture. The encoder calculates a contextual meaning of the input text token sequence by a self-attention mechanism, and generates a hidden state tensor. The decoder refers to the hidden state tensor and the culture code vector, and autoregressively generates a text token sequence of a target language. For example, the input data includes a text character string converted from Japanese voice and a multidimensional vector indicating a formal business culture of the UK. Output data of the decoder includes a translated English text character string and a floating-point array indicating a generation probability of each word. The server inputs the generated text token sequence to a voice synthesis engine, and generates voice waveform data of the target language. The server streaming-distributes this voice waveform data to the staff terminal in real time. By this process, the system algorithmically resolves not only language barriers but also misunderstandings due to differences in cultural nuances. As a technical effect, the system facilitates communication between multinational staff and customers, and improves a closing rate of business negotiations. As a specific application field, the system is applied to a multilingual interpretation system that supports detailed customer service in consideration of local culture in a virtual showroom that sells expensive real estate and automobiles to overseas customers.

Step 3: Emotion Recognition and Visualization of Willingness to Buy The server multidimensionally analyzes the emotional state of the customer from tones of messages and utterances, facial expressions, gestures, voice intonations, chat input speeds, usage frequencies of emojis and stamps, avatar movements, changes in purchasing behavior, frequencies of adding to or deleting from a cart, review posting contents, feedback comments, emotion analysis by SNS linkage, comparisons with past purchasing experiences, and the like using an emotion recognition algorithm by the generative AI, and visualizes it on a screen of the terminal with icons, color coding, avatar facial expression changes, emotion graphs, heat maps, real-time emotion scores, willingness to buy indicators, satisfaction meters, repeat intention scores, churn risk alerts, and the like. An example of a prompt to the generative AI includes “Please analyze the current emotional state and willingness to buy from the chat history and purchasing behavior of this customer, and generate a score for visualization.” Specifically, the server executes a multimodal emotion recognition pipeline. The server synchronizes time-series data including a character string of a text chat, an acoustic feature amount of voice data, and an operation log of the avatar received from the customer terminal. The server inputs the text character string to a natural language processing model, and extracts a sentiment vector indicating emotional polarity. The server inputs the voice data to a convolutional neural network, and extracts an acoustic emotion vector indicating a voice tone and intonation. The server calculates a moving speed and a frequency of gestures from the operation log of the avatar, and generates a behavioral feature vector. The server concatenates these vectors in a combining layer to construct an integrated feature tensor. The server inputs this integrated feature tensor to a fully connected layer, and outputs an emotion score vector indicating a probability distribution for basic emotion classes such as joy, anger, sadness, and surprise. For example, the output data includes a floating-point array indicating that a probability of joy is 0.8 and a probability of anger is 0.05. The server smooths this emotion score vector in time series, and calculates a scalar value indicating the willingness to buy. The server transmits this scalar value to a drawing engine of the terminal, and applies it as a display parameter of a heat map or a meter on the screen. By this process, the system quantifies minute non-verbal information that human staff tend to overlook, and presents it as an objective index. As a technical effect, the system detects signs of customer dissatisfaction and churn at an early stage, and enables the staff to perform follow-up at an appropriate timing. As a specific application field, the system is applied to a sales support tool that grasps the psychological state of the customer in real time and notifies the staff of an optimal timing for closing in face-to-face sales of expensive products online.

Step 4: Promotion and Customer Service Optimization Proposal by AI The server automatically generates cross-sell and up-sell proposals at a timing when the customer's willingness to buy increases using the generative AI, and displays personalized promotion messages such as “This is also recommended for those who purchased this product,” “There is a discount for a set purchase now,” “Gift wrapping is also available,” and “Points will be awarded for posting a review” in real time. In addition, the server analyzes the response history of the staff and the feedback of the customer, and automatically generates advice and training plans for improving customer service quality. Examples of prompts to the generative AI include “Please extract products that customers in the Asian region were interested in and the reasons therefor from the chat history of the past month, and propose three promotion plans,” “Please analyze expression patterns with high satisfaction from the response history of the staff to customer questions,” and the like. Specifically, the server detects that the scalar value of the willingness to buy output from the emotion recognition pipeline has exceeded a predetermined threshold value. The server activates a recommendation system module triggered by this detection event. The recommendation system module inputs a past purchase history vector of the customer and a feature amount vector of a currently browsed product to a collaborative filtering algorithm. The collaborative filtering algorithm performs matrix factorization with a data group of other customers having similar purchasing trends, and outputs a score list of recommendation candidate products. The server extracts the top three product IDs having the highest scores. The server inputs the extracted product IDs and the culture code vector of the customer to a generative AI model. The generative AI model generates a token sequence of a promotion text combining the features of the products and the cultural background of the customer. For example, the input data includes a JSON object including metadata of the recommended products and a text array of promotion sentences to which the customer had a good reaction in the past. Output data of the generative AI model includes a character string of a personalized proposal message and a time stamp indicating a display timing. The server transmits the generated proposal message to the user interface unit of the customer terminal, and causes it to be displayed as a pop-up window. By this process, the system executes a dynamic proposal perfectly matching the current psychological state and context of the customer, rather than a uniform advertisement display. As a technical effect, the system statistically significantly improves success rates of cross-selling and up-selling, and maximizes a customer unit price. As a specific application field, the system is applied to an AI concierge function that proposes accessories and related products suitable for a specific product in a natural conversation format at the moment the customer puts the product into a cart in a virtual department store.

Step 5: Purchasing Behavior Analysis and Store Operation Optimization The server accumulates behavior histories of the customer in the virtual space (product browsing history, chat history, purchase history, feedback history, questionnaire results, evaluation scores, store visit frequency, stay time, cart addition history, settlement method, return history, review posting content, SNS share history, friend invitation history, event participation history, coupon usage history, promotion reaction history, staff response history, transition of popular products, sales fluctuation by season, purchasing trend by region, local economic indicators, local weather information, local traffic information, local logistics status, local law and regulation changes, etc.), past promotion effects, staff response histories, transitions of popular products, sales fluctuations by season, purchasing trends by region, and the like as long-term memory, and multidimensionally and time-serially analyzes these large amounts of data using the generative AI. For example, the server transmits prompts to the generative AI, such as “Please extract customers with a high churn risk from the purchasing data and chat history of the past month, and propose three measures for promoting a revisit to the store,” “Please generate a product description text corresponding to a change in local laws and regulations,” and “Please generate a response plan for maintaining customer satisfaction at the time of a local logistics delay.” Specifically, the server periodically batch-processes a large-scale behavior history log accumulated in a data warehouse. The server extracts session data for each customer from the behavior history log, and shapes it as a time-series event sequence. The server inputs this event sequence to an autoencoder-based anomaly detection model. The anomaly detection model has learned patterns of normal purchasing behavior, and calculates a reconstruction error of the input event sequence. The server extracts a session having a large reconstruction error and not finally leading to a purchase as a pattern with a high churn risk. The server inputs the extracted patterns to a clustering algorithm, and groups them by churn factor. The server inputs a representative feature amount vector of each group to the generative AI model. The generative AI model analyzes the churn factors and generates a text report indicating improvement measures. For example, the input data includes a numerical array indicating a time-series transition of a cart abandonment rate in a specific region, and text data of a news article regarding a logistics delay in the corresponding region. Output data of the generative AI model includes a template of an apology message to the customer for the logistics delay, and definition data of a business flow proposing an alternative delivery option. The server displays the generated response plan on a dashboard of a store manager. By this process, the system discovers a correlation that is difficult for humans to notice from a huge amount of log data, and converts it into a specific action plan. As a technical effect, the system automatically identifies a bottleneck in store operation and supports data-driven decision making, thereby improving overall sales. As a specific application field, the system is applied to a management strategy planning support system for quickly responding to changes in market trends and external factors in each region in an e-commerce company expanding globally.

Step 6: Information Provision and Operation by User Interface On the terminal side, a multilingual and multicultural interface is provided so that the user can intuitively perform avatar operation in the virtual space, product browsing, cart operation, settlement processing, review posting, feedback input, approval/rejection of AI proposals, friend invitation, SNS sharing, coupon acquisition, event participation, questionnaire answering, promotion video viewing, live streaming participation, interactive exhibition experience, virtual fitting, virtual tasting, virtual experiential demonstration, local currency display switching, local delivery option selection, local settlement means selection, barrier-free setting, kids mode setting, privacy mode setting, and the like. Store layout information, a product list, a translated and culturally adapted product description, visualization information of an emotional state, promotion information, a message from the staff, a purchase history, privilege information, a store visit status of a friend, event holding information, a review ranking, an SNS share button, a coupon acquisition button, a questionnaire answer button, a live streaming participation button, a virtual fitting button, and the like transmitted from the server are displayed in real time. Specifically, the terminal processes data received from the server using a built-in processor and graphics processing unit. The terminal caches three-dimensional mesh data and texture data of the store layout transmitted from the server in a local memory. The terminal samples a touch panel operation or an input signal of a controller from the user, and calculates a moving vector and a line-of-sight vector of the avatar. The terminal updates a transformation matrix of a virtual camera based on these vectors, and redraws a scene of the virtual space at a rate of 60 frames per second or more. The terminal processes translated text messages and emotion score data asynchronously received from the server in a thread different from a main drawing loop. The terminal dynamically changes transparency and hue of a user interface element on the screen based on numerical data of the emotion score. For example, the terminal normalizes a value of the willingness to buy indicator to a range of 0 to 1, and uses this value as an interpolation coefficient of a color gradation from red to green. When detecting that the user has pressed the virtual fitting button, the terminal activates a camera of the terminal and extracts skeletal feature points of the user. The terminal synthesizes the extracted skeletal feature points and a three-dimensional model of the product, and superimposes and displays them on an augmented reality space. By this process, the system optimally distributes computational resources of the server and the terminal, and provides a rich user experience while suppressing consumption of a network bandwidth. As a technical effect, the system minimizes an operation delay, and improves a sense of immersion and interactivity in the virtual space. As a specific application field, the system is applied to a next-generation online shopping application that allows consumers to perform realistic product confirmation and fitting experiences as if they were in an actual store while staying at home.

### Specific Use Case

For example, assume a case where a multinational brand having bases in three regions of Asia, Europe, and North America operates a virtual store for customers around the world. The virtual store space generation unit receives a language used, a cultural background, a time zone, a purchase history, products of interest, avatar settings, a desired customer service style, an age group, a gender, past feedback, a purchase frequency, a store visit time zone, a preferred payment method, a type of terminal used, hobby and preference information by SNS linkage, a past browsing history, friend relationships, local trend information, and the like of each customer, automatically generates a layout reflecting decorations and BGM tailored to local holidays and events, local currency display, local delivery options, and local popular product rankings for customers in the Asian region, and provides a virtual space optimized for each region, such as a sustainable product feature area and promotions reflecting local trends for customers in the European region, and a family-friendly kids' space, a limited product area linked to local events, and support for local electronic payment services for customers in the North American region. Specifically, the virtual store space generation unit receives access requests from customers in each region via a load balancer. The virtual store space generation unit identifies a geographical location from an IP address of an access source, and transmits an API request to an external data source in a corresponding region. The virtual store space generation unit parses the acquired data of local holiday information and popular product rankings in a JSON format. The virtual store space generation unit combines an attribute information vector of the customer and the acquired external data vector, and inputs the combined vector to a space layout generation model. The space layout generation model functions as a generator of a generative adversarial network. The generator outputs three-dimensional voxel data of the virtual space based on the input vector. For example, the input data includes a categorical variable indicating a customer in the Asian region, and a flag value indicating a local Lunar New Year event. Output data of the generator includes an arrangement coordinate tensor of a decoration object based on red and gold, and metadata instructing price display in a local currency. The virtual store space generation unit converts the generated voxel data into a polygon mesh, and transmits the polygon mesh to a customer terminal. By this process, the system dynamically generates completely independent customized spaces for each region in parallel on a single platform. As a technical effect, the system provides a purchasing environment with the highest affinity for customers in each region, and strengthens brand loyalty in a global market. As a specific application field, the system is applied to a global marketing platform that automatically switches exhibition contents and productions according to a residential area of a participant in a virtual new product launch event held simultaneously worldwide.

When a customer asks a question in Japanese, “What material is this product made of?”, the communication support unit transmits a prompt to the generative AI, “Please translate ‘What material is this product made of?’ spoken in Japanese into a formal English expression of British culture,” and transmits it to the staff in culturally adapted English as “What material is this product made of?”. Conversely, when an American customer asks a question, “What is the origin of this product?”, the communication support unit transmits a prompt to the generative AI, “Please translate ‘What is the origin of this product?’ spoken in American English into a polite Japanese expression of the Japanese cultural sphere,” and transmits it to the staff in polite Japanese such as “This product is manufactured in a traditional Japanese workshop.” Furthermore, the generative AI automatically performs a cultural adaptation process by referring to the cultural background and past communication history of each user, purchasing trends by country, religious considerations, gender expressions, switching between honorific and casual expressions, non-verbal expressions, local buzzwords, dialects, slang, industry terms, technical terms, abbreviations, product proper nouns, brand stories, local advertising expressions, local consumer protection regulations, local ethical norms, local social values, and the like. Specifically, the communication support unit converts voice input of the customer into text, and identifies a source language by a language determination module. The communication support unit loads a weight parameter of an appropriate translation model into a memory based on a pair of the identified source language and a target language. The communication support unit combines a token sequence of the input text and an instruction prompt constructed by a prompt generation module, and inputs the combined token sequence and instruction prompt to a large language model. The instruction prompt includes a control vector specifying a direction of translation, a cultural tone, and a level of honorifics. For example, the input data includes a Japanese character string “What material is this product made of?” and a metadata tag specifying “a formal English expression of British culture”. The large language model analyzes a contextual dependency between input tokens using a self-attention mechanism of a transformer. The large language model generates and outputs a token sequence of the target language. The output data includes an English character string “What material is this product made of?” and a score value indicating a certainty factor of translation. The communication support unit transfers this output character string to a chat interface of a staff terminal. By this process, the system executes highly advanced semantic conversion with a deep understanding of context and cultural background, rather than simple dictionary-based replacement. As a technical effect, the system eliminates cultural friction between customers and staff, and promotes construction of a relationship of trust. As a specific application field, the system is applied to an automatic translation system that responds with appropriate wording tailored to manners and customs of each country at a virtual concierge desk of a luxury hotel targeting multinational customers.

The purchasing behavior analysis unit accumulates behavior histories of customers (product browsing history, chat history, purchase history, feedback history, questionnaire results, evaluation scores, store visit frequency, stay time, cart addition history, payment method, return history, review posting content, SNS share history, friend invitation history, event participation history, coupon usage history, promotion reaction history, staff response history, transition of popular products, seasonal sales fluctuation, purchasing trend by region, local economic indicator, local weather information, local traffic information, local logistics status, local legal regulation change, etc.) as long-term memory, transmits prompts to the generative AI such as “Extract customers with a high risk of leaving from purchasing data and chat history for the past month, and propose three measures to promote revisiting,” “Extract products that customers in the Asian region were interested in and reasons therefor from chat history for the past month, and propose three promotion plans,” “Analyze expression patterns with high satisfaction from staff response history to customer questions,” “Generate a product description corresponding to a local legal regulation change,” and “Generate a response plan to maintain customer satisfaction during a local logistics delay,” and automatically executes extraction of popular products, purchasing trend analysis by cultural sphere, optimization proposal of customer service quality, automatic generation of promotion plans, presentation of staff training plans, design of benefits for repeaters, extraction of VIP customers and presentation of special response plans, revisiting promotion measures for customers with a high risk of leaving, cart abandonment countermeasures, return prevention measures, review promotion measures, SNS diffusion promotion measures, friend invitation campaign design, event participation promotion measures, local event-linked promotions, customer response plans during local logistics delays, sales strategy adjustment plans during local legal regulation changes, and the like based on results of multidimensional and time-series analysis by the AI. Specifically, the purchasing behavior analysis unit aggregates petabyte-class behavior history logs stored in a distributed file system using a parallel data processing framework. The purchasing behavior analysis unit constructs the aggregated data as a multidimensional tensor, and inputs the multidimensional tensor to a time-series prediction model. The time-series prediction model adopts a hybrid architecture combining a convolutional neural network and a long short-term memory network. The time-series prediction model simultaneously learns spatial features and temporal transitions of past purchasing patterns. The purchasing behavior analysis unit combines an output result of the time-series prediction model and an instruction prompt for the generative AI, and inputs the combined output result and instruction prompt to a large language model. For example, the input data includes a time-series array indicating sales transitions of a specific product for the past month, and a natural language prompt character string “Extract customers with a high risk of leaving, and propose three measures to promote revisiting.” The large language model integrally interprets the input numerical data and text instructions, and generates specific measure plans. The output data is a structured JSON object including a title of a proposed promotion, a conditional expression of a target customer segment, and a predicted value of an expected effect. The purchasing behavior analysis unit parses this JSON object, and transmits the parsed JSON object to a marketing automation system as an execution command. By this process, the system automates a process from data analysis to measure planning and execution end-to-end without human intervention. As a technical effect, the system dramatically improves a response speed to market changes, and minimizes opportunity loss. As a specific application field, the system is applied to an autonomous store operation system that analyzes daily sales data and customer feedback in real time and automatically optimizes a sales strategy for the next day in a large-scale e-commerce site handling tens of thousands of products.

The user interface unit provides a multilingual and multicultural interface so that a customer can intuitively perform avatar operation in the virtual space, product browsing, cart operation, payment processing, review posting, feedback input, approval/rejection of AI proposals, friend invitation, SNS sharing, coupon acquisition, event participation, questionnaire answering, promotion video viewing, live distribution participation, interactive exhibition experience, virtual fitting, virtual tasting, virtual experiential demo, local currency display switching, local delivery option selection, local payment method selection, barrier-free setting, kids mode setting, privacy mode setting, and the like. For example, when a customer enters a virtual store from a terminal, store layout information and a product list optimized for the customer, translated and culturally adapted product descriptions, visualization information of an emotional state, promotion information, messages from staff, a purchase history, benefit information, a store visit status of a friend, event holding information, a review ranking, an SNS share button, a coupon acquisition button, a questionnaire answer button, a live distribution participation button, a virtual fitting button, and the like are transmitted from a server to the terminal, and the terminal displays these in real time. Specifically, the user interface unit utilizes a WebGL-based rendering engine operating on a web browser of the customer terminal. The user interface unit asynchronously receives update data of the store layout information and the product list from the server via WebSocket communication. The user interface unit stores the received data in a local state management library, and updates a virtual DOM tree. The user interface unit processes operation input of movement and viewpoint change of the avatar in the virtual space by rotation calculation using a quaternion. The user interface unit causes the visualization information of the emotional state and the promotion information received from the server to be follow-displayed above a head of the avatar as a billboard object in a three-dimensional space. For example, the user interface unit parses array data of the “purchase history” received from the server, and dynamically maps the parsed array data as a texture of digital signage arranged on a wall surface in the virtual space. When the customer clicks the virtual fitting button, the user interface unit executes a shader program that synthesizes a three-dimensional model of a product and a camera image of the customer in real time using a GPU of the terminal. By this process, the system efficiently processes complex three-dimensional drawing and rendering of multilingual text on the terminal side. As a technical effect, the system provides an intuitive and highly responsive operational feeling to the customer while distributing a load on the server. As a specific application field, the system is applied to a cross-platform compatible e-commerce service that provides a high-quality virtual shopping experience only with a web browser without installing a dedicated application.

In such a use case, specific examples of prompt sentences to be read by the generative AI include “Please translate ‘What material is this product made of?’ spoken in Japanese into a formal English expression of British culture,” “Please translate ‘What is the origin of this product?’ spoken in American English into a polite Japanese expression of the Japanese cultural sphere,” “Extract customers with a high risk of leaving from purchasing data and chat history for the past month, and propose three measures to promote revisiting,” “Extract products that customers in the Asian region were interested in and reasons therefor from chat history for the past month, and propose three promotion plans,” “Analyze expression patterns with high satisfaction from staff response history to customer questions,” “Generate a product description corresponding to a local legal regulation change,” and “Generate a response plan to maintain customer satisfaction during a local logistics delay.” Specifically, the system formats these prompt sentences into a format compatible with an input interface of a generative AI model. The system converts the prompt sentences into an integer index array by a tokenizer. The system inputs this index array to an encoder of a transformer model. In order to accurately transmit an intention of the prompt sentences to the model, the system adds a definition of a system role and constraint conditions to a head of input text using a prompt engineering technique. For example, the input data is a text tensor including a system prompt “You are an excellent multicultural communication assistant” and a user prompt “Please translate ‘What material is this product made of?’ spoken in Japanese into a formal English expression of British culture.” The system dynamically adjusts a temperature parameter and a threshold of top-P sampling at the time of output generation of the model, and controls a balance between diversity and accuracy of output. The system inversely converts a text token sequence output from the model into a character string by a decoder. By this process, the system converts ambiguous instructions in natural language into specific tasks executable by a computer, and draws highly accurate inference results. As a technical effect, the system makes it possible to flexibly respond to various use cases with a single general-purpose AI model, and reduces cost and period of system development. As a specific application field, the system is applied to a no-code business support interface that automates complex data analysis and translation tasks by giving instructions to the system in natural language even if store staff does not have programming knowledge.

In this way, the system of the present invention can provide a virtual store experience optimized for language, culture, social background, purchasing trend, and local circumstances to diverse customers around the world, and simultaneously realize maximization of global sales opportunities, improvement of customer satisfaction, and efficiency improvement and optimization of store operation. Specifically, the system functions as a distributed computing architecture integrating the virtual store space generation unit, the communication support unit, the purchasing behavior analysis unit, and the user interface unit. The system exchanges high-dimensional tensor data and embedding vectors between respective modules in real time. The system continuously supplies all input data and behavior logs of customers to an inference pipeline of a machine learning model. The system dynamically updates drawing parameters of the virtual space and weights of a translation model based on inference results. For example, the system sets a stay time and a purchase conversion rate of a customer as an objective function, and autonomously optimizes parameters of the entire system using a reinforcement learning algorithm. The system processes this optimization process in parallel using a GPU cluster on a cloud. By this process, the system completely eliminates static rule-based processing, and constructs an adaptive information processing infrastructure that is data-driven and self-evolving. As a technical effect, the system executes personalization at a scale and speed exceeding human cognitive limits, and establishes a competitive advantage in a global market. As a specific application field, the system is applied as a core system of a next-generation metaverse commerce platform that simultaneously provides services to millions of users across borders and language barriers.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

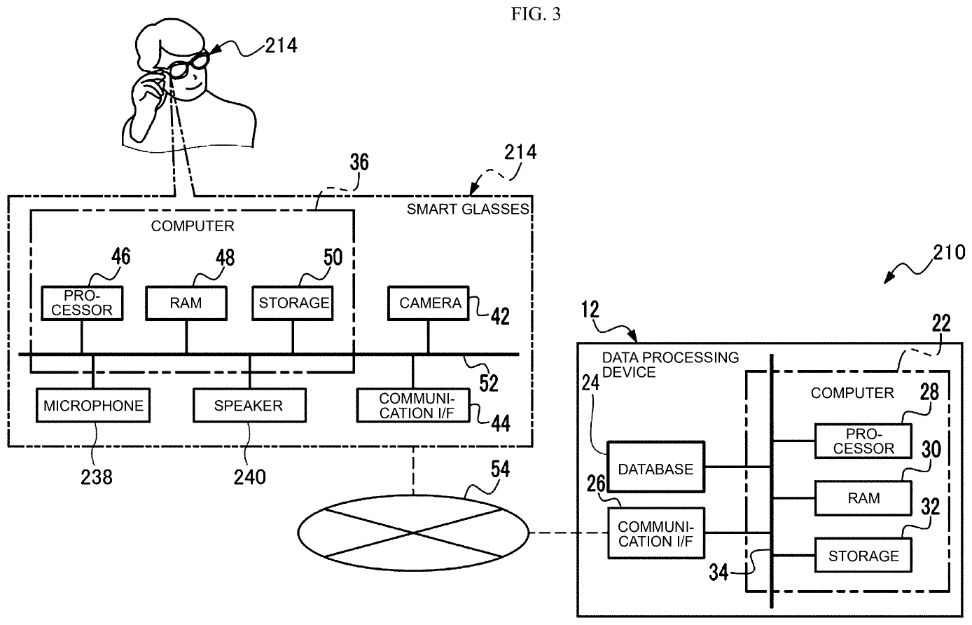

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

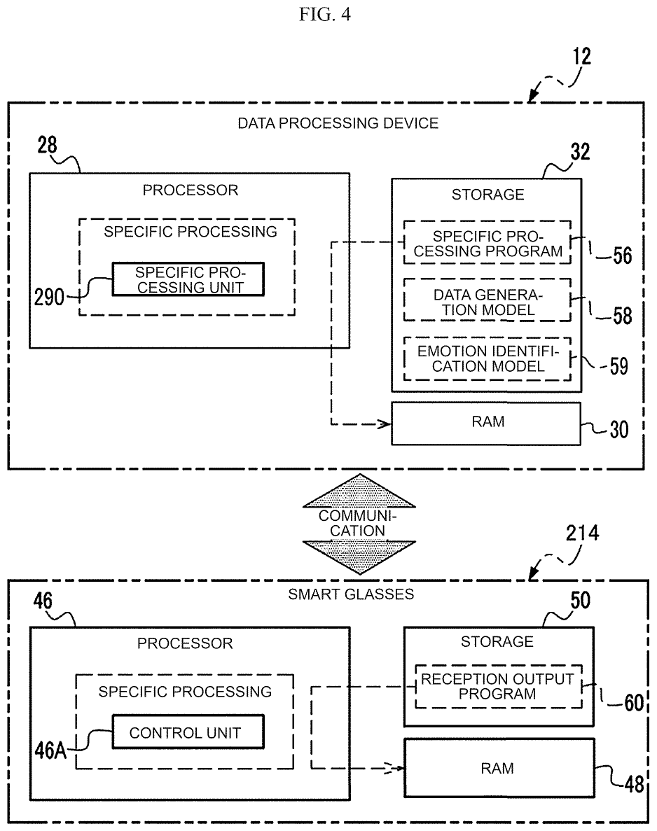

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

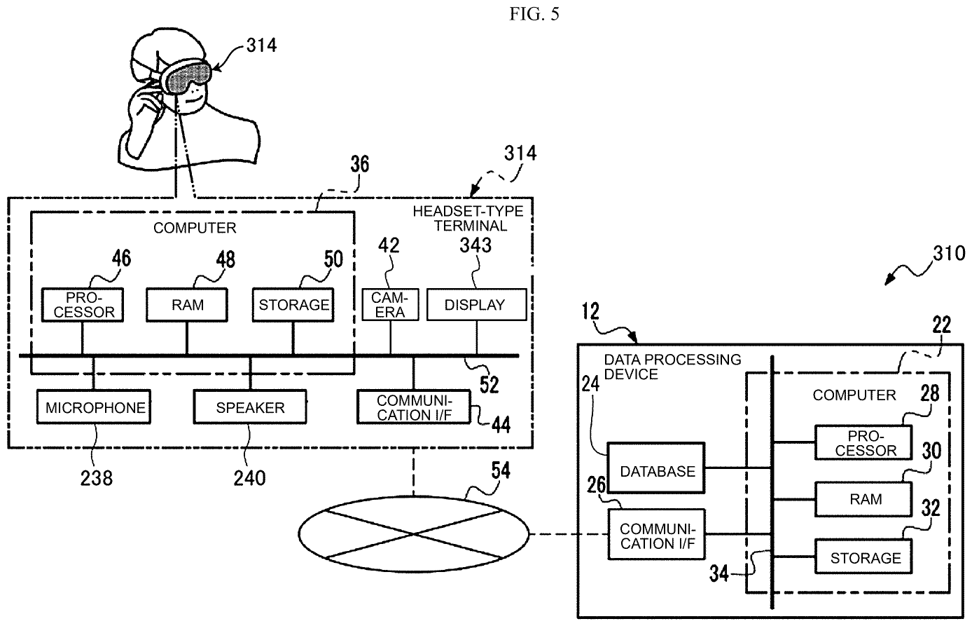

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

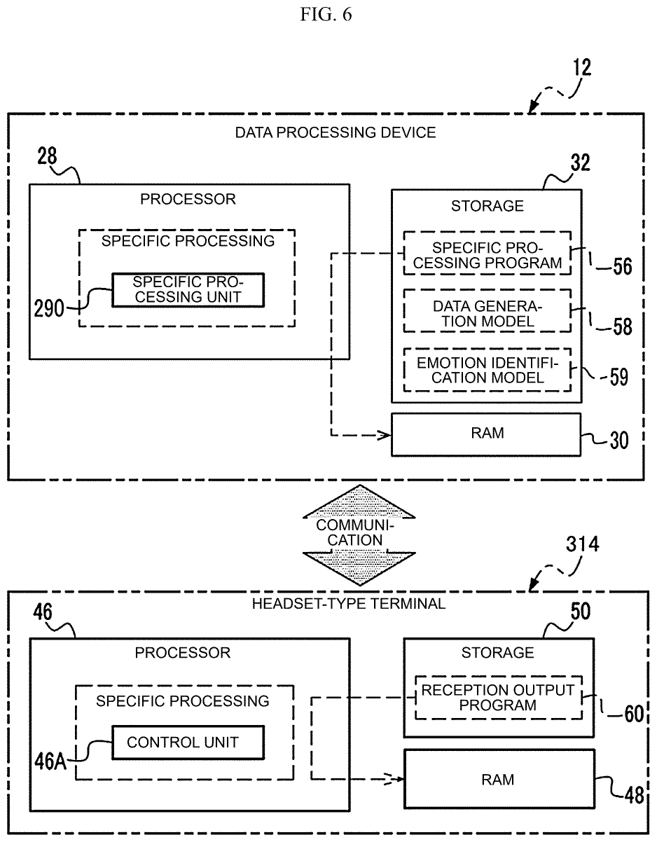

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

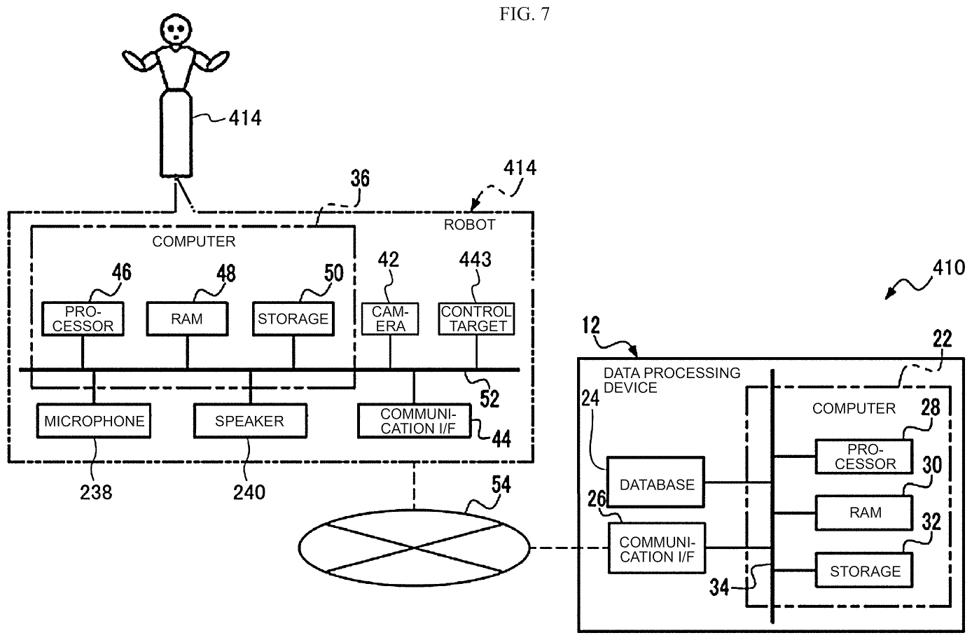

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

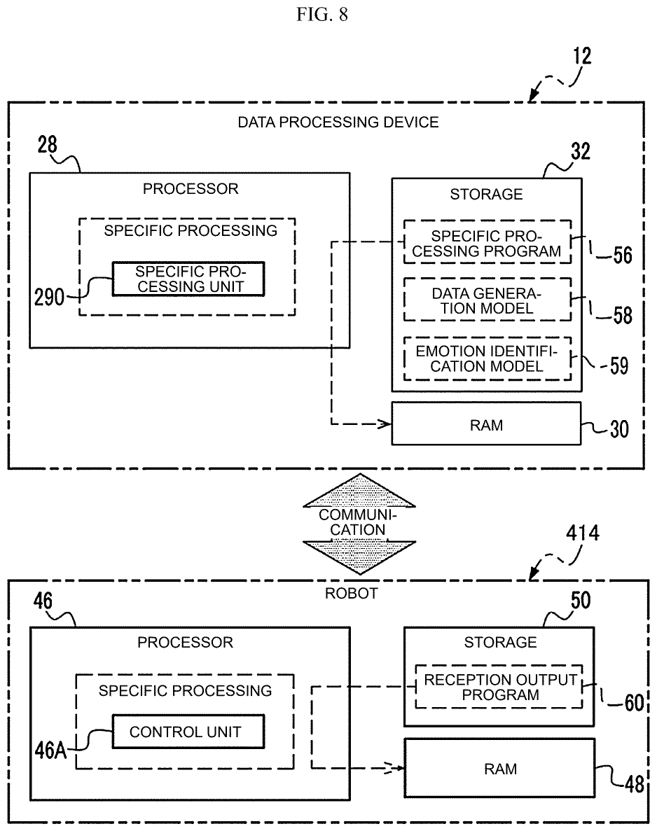

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

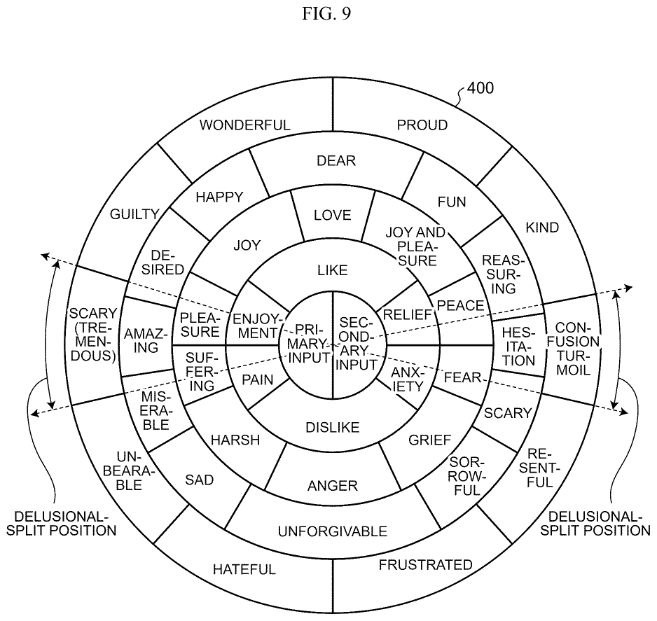

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

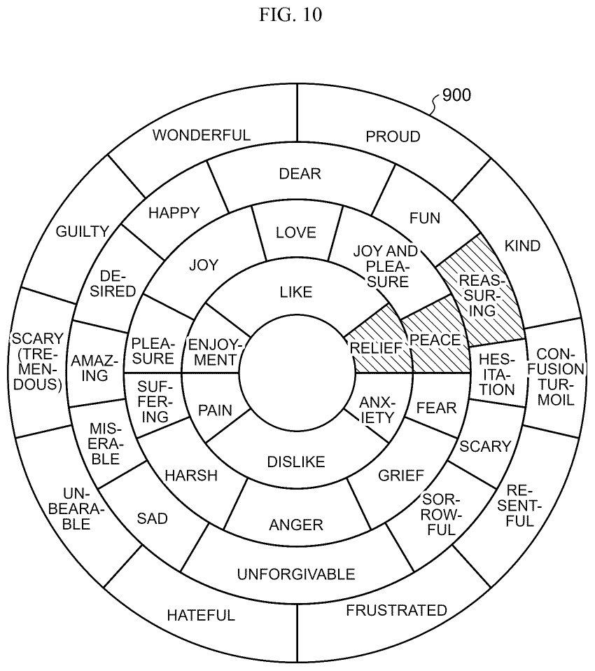

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

(Supplementary Note 1) [0182] A system for realizing multinational and multicultural virtual store operation, the system comprising: a virtual store space generation unit; a communication support unit; and a purchasing behavior analysis unit, wherein the virtual store space generation unit is configured to receive a language used, a cultural background, a time zone, a purchase history, products of interest, avatar settings, a desired customer service style, and the like as attribute information transmitted from customers and staff around the world, and generate a virtual store space in which multinational and multicultural customers and staff can simultaneously participate based on the information; the communication support unit is configured to translate text or voice inquiries, product descriptions, and customer service responses between the customers and the staff into multiple languages in real time using generative AI, further automatically perform a cultural adaptation process by referring to the cultural background and past communication history of each user, purchasing trends by country, religious considerations, gender expressions, switching between honorific and casual expressions, meanings of non-verbal expressions, and the like, additionally apply an emotion recognition algorithm by the generative AI to analyze an emotional state of the exchanged messages and responses, and visualize customer satisfaction and willingness to buy; and the purchasing behavior analysis unit is configured to accumulate behavior histories, chat histories, product browsing histories, purchase histories, feedback histories, questionnaire results, evaluation scores, and the like of the customers in the virtual space as long-term memory, extract popular products, analyze purchasing trends by cultural sphere, propose optimization of customer service quality, automatically generate promotion plans, present staff training plans, and the like through highly accurate data analysis by the generative AI, wherein all of these processes are integrally and autonomously executed by the generative AI.

(Supplementary Note 2) [0183] The system according to Supplementary Note 1, wherein the virtual store space generation unit is configured to acquire external data such as national holidays, events, seasons, local trends, laws and regulations, logistics statuses, exchange rate information, and popular product rankings by region in addition to the attribute information of the customers and the staff, dynamically optimize a layout, product display, promotion display, customer service style, event production, product description content, and the like in the virtual space based on the information, and further automatically provide a virtual store experience optimized for each country and each cultural sphere using the generative AI.

(Supplementary Note 3) [0184] The system according to Supplementary Note 1, wherein the communication support unit is configured to translate messages between the customers and the staff into multiple languages in real time using a natural language processing function by the generative AI, further automatically perform selection of expressions, switching between honorific and casual expressions, avoidance of cultural taboos, adjustment of strength of emotional expressions, automatic generation of expressions that increase willingness to buy, personalization of promotion messages, and real-time visualization of customer satisfaction by the emotion recognition algorithm by referring to the cultural background, purchase history, past communication history, purchasing trend, and feedback content of each user, and additionally autonomously execute additional explanations and cross-sell/up-sell proposals by the AI as necessary.

What is claimed is:

1. A system comprising:
circuitry configured to:
receive, via a communication interface coupled to a packet-switched network, text data and audio data from terminal devices at a plurality of geographically distributed locations, and store received session data in a storage device;
apply a speech recognition model to audio data to generate transcript text, and apply a real-time neural machine translation model to translate the transcript text and text data into target language data corresponding to each recipient terminal device's locale parameter;
apply a cultural adaptation model to the translated text data to adjust expression patterns and nuance parameters according to cultural background attribute data associated with each recipient terminal device, and apply an emotion analysis model to the session data to generate an emotion state indicator for each participant;
generate a three-dimensional virtual environment data record by applying a three-dimensional graphics engine to spatial configuration data and avatar representation data associated with each participant, and synchronize the virtual environment state across all participant terminal devices via the communication interface; and
transmit the translated and culturally adapted text data, the emotion state indicators, and the virtual environment data record to terminal devices via the communication interface.

2. The system according to claim 1, wherein the circuitry is configured to apply the speech recognition model to audio waveform data received from terminal devices by converting analog audio signals to digital pulse code modulation format, applying noise reduction filters, and decoding the filtered audio to generate transcript text using a transformer-based acoustic model.

3. The system according to claim 2, wherein the circuitry is configured to apply the real-time neural machine translation model to the transcript text and text data using a sequence-to-sequence architecture with attention mechanisms, generate translated output text in target languages corresponding to each participant's locale parameter, and minimize translation latency by executing inference on a dedicated inference server cluster equipped with graphics processing units.

4. The system according to claim 1, wherein the circuitry is configured to apply the cultural adaptation model by retrieving cultural norm reference records from a vector database using a query embedding derived from the translated text data, and applying the generative neural network model to rephrase or reframe translated expressions according to cultural norm parameters associated with each recipient's cultural background attribute data.

5. The system according to claim 1, wherein the circuitry is configured to apply the emotion analysis model to the session data by tokenizing text data and computing attention-weighted representations of emotionally significant token sequences, compute an emotion state score on a multi-dimensional valence-arousal scale, and generate the emotion state indicator for each participant comprising categorical emotion labels and intensity values.

6. The system according to claim 5, wherein the circuitry is configured to detect a communication tension indicator when an emotion state indicator exceeds a tension threshold parameter, apply the generative neural network model to generate a facilitation suggestion text, and transmit the facilitation suggestion text to a designated session moderator terminal device.

7. The system according to claim 1, wherein the circuitry is configured to generate avatar representation data for each participant by applying a generative adversarial network to participant avatar profile data and virtual environment spatial configuration data, and render a real-time composite scene by integrating avatar representation data from all participants in a shared three-dimensional coordinate space.

8. The system according to claim 1, wherein the circuitry is configured to apply a behavior log analysis model to interaction event records accumulated in the storage device to extract collaboration pattern feature vectors, compute a collaboration effectiveness score for each participant pair, and generate a collaboration insight report for transmission to session administrator terminal devices.

9. The system according to claim 1, wherein the circuitry is configured to apply a task progress tracking model to session data and task state records in the storage device to generate a task completion prediction score for each tracked task identifier, and generate a task alert notification when a task completion prediction score falls below a deadline risk threshold.

10. The system according to claim 9, wherein the circuitry is configured to generate a session summary data record by applying the generative neural network model to session transcript data and task state records, the session summary comprising extracted decision records, action item lists, and unresolved issue indicators, and transmit the session summary data record to all participant terminal devices upon session completion.

11. The system according to claim 1, wherein the circuitry is configured to establish bidirectional real-time communication sessions with each terminal device using a WebSocket protocol, maintain session state data comprising participant connection status and message ordering sequence numbers, and apply a message ordering algorithm to ensure consistent message delivery order across all participant terminal devices.

12. The system according to claim 1, wherein the circuitry is configured to apply a distributed database architecture to store session data records across a plurality of geographic data center nodes, apply a data replication protocol to maintain consistency across nodes, and minimize access latency by routing terminal device requests to the geographically nearest available node.

13. The system according to claim 1, wherein the circuitry is configured to update the cultural adaptation model by generating training pairs from historical translated and adapted text data records and corresponding validated cultural appropriateness ratings, and fine-tune the model to improve cultural adaptation accuracy for specific locale parameter pairs.

14. The system according to claim 1, wherein the circuitry is configured to apply a content item recommendation model to the session data and participant attribute data to generate contextually relevant reference document recommendations, retrieve recommended reference documents from the storage device by cosine similarity search, and transmit reference document data to participant terminal devices.

15. The system according to claim 1, wherein the circuitry is configured to encrypt all data transmissions between participant terminal devices and the system using an end-to-end encryption protocol, and authenticate each terminal device session using a token-based authentication mechanism prior to accepting session data.

16. The system according to claim 1, wherein the circuitry is configured to generate a language pair performance report by aggregating translation quality scores across all session data records for each source-target language pair, and apply the generative neural network model to identify systematic translation issues for specific cultural background parameter combinations.

17. The system according to claim 1, wherein the terminal devices are located at geographically distributed sites, each participant is associated with a locale parameter and a cultural background attribute data record, and the real-time neural machine translation and cultural adaptation pipeline produces recipient-specific text data for each participant from a single source utterance.

18. A system comprising:
circuitry configured to:
receive, via a communication interface coupled to a packet-switched network, audio data and text data from terminal devices at distributed locations;
apply a speech recognition model to generate transcript text, apply a real-time neural machine translation model to generate target language data, and apply a cultural adaptation model to adjust expressions according to cultural background attribute data;
apply an emotion analysis model to generate emotion state indicators, and generate three-dimensional virtual environment data by applying a three-dimensional graphics engine to spatial configuration and avatar data;
detect communication tension indicators and generate facilitation suggestions using a generative neural network model; and
transmit translated and adapted text data, emotion state indicators, and virtual environment data to terminal devices via the communication interface.

19. The system according to claim 18, wherein the circuitry is configured to apply a behavior log analysis model to generate collaboration effectiveness scores, apply a task progress tracking model to generate task completion prediction scores, and generate session summary data records comprising extracted decision records and action item lists by applying the generative neural network model to session transcript data.

20. A method comprising:
receiving, via a communication interface coupled to a packet-switched network, text data and audio data from terminal devices at geographically distributed locations, and storing session data in a storage device;
applying a speech recognition model to generate transcript text, and applying a real-time neural machine translation model to generate target language data for each recipient locale parameter;
applying a cultural adaptation model to adjust expression patterns and applying an emotion analysis model to generate emotion state indicators;
generating a three-dimensional virtual environment data record and synchronizing it across participant terminal devices; and
transmitting translated and adapted text data, emotion state indicators, and virtual environment data to terminal devices via the communication interface.
